(19) United States
(12) Patent Application Publication
(10) Pub. No.: US 2012/0226614 A1
(43) Pub. Date: Sep. 6, 2012

(54) Group Electronic Purchase

(75) Inventors: Maya Gura, Ramat Sharon (IL); Ron Gura, Tel Aviv. (IL); Matan Bar, Tel Aviv. (IL); Erez Dickman, Tel Aviv. (IL)

(73) Assignee: eBay, Inc., San Jose, CA (US)

(21) Appl. No.: 13/409,572

(22) Filed: Mar. 1, 2012

Related U.S. Application Data
(60) Provisional application No. 61/447,755, filed on Mar. 1, 2011.

(51) Int. Cl. G06Q 20/40

(52) U.S. Cl. 705/44

(57) ABSTRACT

Payment for a purchase is facilitated wherein members of a group contribute to the payment. A memory can store account information for a plurality of contributing users and for a purchasing user. A processor can be operable to receive a communication indicating an agreement of each of the contributing users to participate in a group purchase transaction. The participation can include transferring money from the contributing users to the purchasing user. The processor can be further operable to access accounts of the contributing users and the purchasing user, transfer money from the accounts of the contributing users into the account of the purchasing user, and authorize the group purchase transaction with a merchant for the purchasing user. In this manner, a more expensive item may be purchased, such as for a gift, than may be purchase by an individual member of the group.

### PRIORITY CLAIM

This application claims the benefit of U.S. Provisional Application No. 61/447,755, filed Mar. 1, 2011, the entire contents of which are hereby expressly incorporated by reference.

### BACKGROUND

1. Technical Field

The present disclosure generally relates to electronic purchase transactions and, more particularly, relates to facilitating a group electronic purchase transaction wherein a plurality of people cooperate to make a purchase.

2. Related Art

Electronic purchase transactions are common. Electronic purchase transactions include purchase transactions made using credit cards, debit cards, gift cards, and the like. A payment provider, such as Paypal, Inc., can be used in place of a credit card, debit card, or gift card to facilitate payment for items purchased. Electronic purchase transactions can take place in brick and mortar stores. Electronic purchase transactions can take place over a network, such as the Internet. For example, a user can order an item from an online retailer, pay for the item via a payment provider, and have the item delivery to the user.

Social networks allow groups of people to readily communicate with one another. The communication facilitated by social networks facilitates social ecommerce. Social commerce is electronic commerce that can involve social networks.

### SUMMARY

The combination of group communication provided by a social network and online retailers facilitates social ecommerce. In social ecommerce, a group can interact with respect to a purchase. For example, members the group can confer regarding what to buy, where to buy, best prices, desired features, and the like. Social networks and online retailers can work independently or can cooperate to provide various tools that can encourage online purchases. For example, customer ratings, reviews, recommendations, and referrals can make online purchase decisions easier.

According to one or more embodiments, methods and systems are provided for facilitating payment for a purchase wherein members of a group contribute to the payment. The group can agree upon a purchase. That is, the group can agree upon what to purchase, where to make the purchase, and/or what to pay for the purchase. One member of the group can be referred to as a purchasing user. Money can be transferred to the purchasing user from other members of the group. The other members of the group can be referred to as contributing users. The money can then be used by the purchasing user to make the purchase. The purchase can be for a member of the group or for any other person. The purchase can be a gift for a member of the group for or any other person.

According to one or more embodiments, a memory can store account information for a plurality of contributing users and for a purchasing user. A processor can be operable to receive a communication indicating an agreement of each of the contributing users to participate in a group purchase transaction. The participation can include transferring money from the contributing users to the purchasing user. The processor can be further operable to access accounts of the contributing users and the purchasing user, transfer money from the accounts of the contributing users into the account of the purchasing user, and authorize the group purchase transaction with a merchant for the purchasing user. The purchasing user can thus make the purchase on behalf of the contributing users. In this manner, the cost of the purchase can be shared among the members of the group. Since the cost of the purchase is shared, a more expensive item may be purchased.

### BRIEF DESCRIPTION OF THE DRAWINGS

FIG. 1 is a block diagram showing a group purchase system, in accordance with one or more embodiments;

FIG. 2 is a flow chart showing an overview of operation of the group purchase system, in accordance with one or more embodiments;

FIG. 3 is a flow chart showing more detailed operation of the group purchase system, in accordance with one or more embodiments;

FIG. 4 is a block diagram showing a registration/installation process, in accordance with one or more embodiments;

FIG. 5 is a block diagram showing installation and loading, in accordance with one or more embodiments;

FIG. 6 is a series of screens showing process flow for starting a group purchase transaction, in accordance with one or more embodiments;

FIG. 7 is a series of screens showing process flow for group member chipping in to a group purchase transaction, in accordance with one or more embodiments;

FIG. 8 is a series of screens showing process flow for tracking a group purchase transaction, in accordance with one or more embodiments;

FIG. 9 is a flow chart showing process flow for inviting group members to participate in a group purchase transaction, in accordance with one or more embodiments;

FIG. 10 is a screen showing a product page having a widget, in accordance with one or more embodiments;

FIG. 11 is a screen showing a landing page, in accordance with one or more embodiments;

FIG. 12 is a screen showing a landing page including mandatory data as defined by a hosting e-commerce site, in accordance with one or more embodiments;

FIG. 13 is a screen showing an invite friends page for inviting group members to participate in the group purchase transaction, in accordance with one or more embodiments;

FIG. 14 is a screen showing entry of a group members name prior to connecting to a social network or email provider, in accordance with one or more embodiments;

FIG. 15 is a screen showing entry of a group members name after connecting to a social network or email provider, in accordance with one or more embodiments;

FIG. 16 is a screen showing selection of a method for splitting the cost of the item being purchased, in accordance with one or more embodiments;

FIG. 17 is a screen showing contributions of group members split equally, in accordance with one or more embodiments;

FIG. 18 is a screen showing manual editing of the amounts of the contributions, in accordance with one or more embodiments;

FIG. 19 is a screen showing a tooltip helper that can appear to help the organizer to add information such as a missing amount for a specified group member, in accordance with one or more embodiments;

FIG. 20 is a screen showing selection of an occasion, in accordance with one or more embodiments;

FIG. 21 is a screen showing entering of a gift recipient's name, in accordance with one or more embodiments;

FIG. 22 is a screen showing adding of a personal message, in accordance with one or more embodiments;

FIG. 23 is a screen showing a confirmation page, in accordance with one or more embodiments;

FIG. 24 is a screen showing a success page, such as for use when an organizer is already logged in or has used Facebook/Twitter connect to access the group purchase system, in accordance with one or more embodiments;

FIG. 25 is a screen showing a success page such as after clicking on a confirmation link, in accordance with one or more embodiments;

FIG. 26 is a flow chart showing process flow for chipping in, in accordance with one or more embodiments;

FIG. 27 is a screen showing a chip in page that a group member can enter from an email invitation wherein the organizer has suggested an amount to be chipped in, in accordance with one or more embodiments;

FIG. 28 is a screen showing a chip in page that a group member can enter from a Facebook invitation wherein the organizer has suggested an amount to be chipped in, in accordance with one or more embodiments;

FIG. 29 is a screen showing a chip in page that a group member can enter from a shared URL wherein the group sharing app has no information regarding the group member, in accordance with one or more embodiments;

FIG. 30 is a screen showing a chip in success page, in accordance with one or more embodiments;

FIG. 31 is a screen showing a chip in failed page, in accordance with one or more embodiments;

FIG. 32 is a screen showing that the group purchase transaction has failed and was consequently cancelled, in accordance with one or more embodiments;

FIG. 33 is a screen showing a chip in widget, in accordance with one or more embodiments;

FIG. 34 is a flow chart that shows tracking process flow, in accordance with one or more embodiments;

FIG. 35 is a screen showing a track page with organizer tools, in accordance with one or more embodiments;

FIG. 36 is a screen showing a product widget page in a track state and having a floating widget, in accordance with one or more embodiments;

FIG. 37 is a screen showing a product widget page in a track state and having an expanded floating widget, in accordance with one or more embodiments;

FIG. 38 is a screen showing chip in page that can be viewed by a contributing user wherein a group purchase transaction is fully funded, in accordance with one or more embodiments;

FIG. 39 is a screen showing a chip in page that can be viewed by an organizer when the group purchase transaction is fully funded, in accordance with one or more embodiments;

FIG. 40 is a screen showing an email template, in accordance with one or more embodiments;

FIG. 41 is a screen showing user identification on a group gifts plugin, such as a Facebook or Twitter group gifts identification, in accordance with one or more embodiments;

FIG. 42 is a screen showing a page that can be displayed when a group member has forgotten the member's group gifts PIN and is asking to get a new group gifts PIN, in accordance with one or more embodiments;

FIG. 43 is a screen showing a group gifts dashboard that displays active group gifts and completed group gifts, in accordance with one or more embodiments; and

FIG. 44 is a screen showing an email template showing a “View the gift” box, in accordance with one or more embodiments.

### DETAILED DESCRIPTION

According to one or more embodiments, methods and systems are provided for facilitating payment for a purchase wherein members of a group contribute to the payment. The members of the group can be members of a social network, such as Facebook. The members of the group can use the social network to communicate regarding the purchase. For example, the members of the group can use the social network to communicate a desired to make a purchase, to discuss what to purchase and where to make the purchase, to read reviews of the item to be purchased, and to discuss pricing of the item and how the purchase is to be made.

According to one or more embodiments, one member of the group can communicate to other members of the group a desire to make a group purchase a gift. Other members of the group can communicate a desire to participate in the purchase.

According to one or more embodiments, one or more members of the group can communicate with one another regarding what to purchase. Discussions regarding what to purchase can include references to reviews of the item to be purchased and pricing of the item. Alternatively, one member of the group can decide what to purchase and can invite other members of the group to participate in the purchase. The other members of the group can then either decide to participate in the group purchase or can decide not to participate in the group purchase.

According to one or more embodiments, once the item has been selected members of the group can communicate with one another regarding matters such as where the purchase is to be made, which member of the group is to make the purchase on behalf of the group, and how funds are to be transferred to facilitate the purchase. Once these decisions have been made, an agreement can be reached among the members of the group to make the purchase. Alternatively, one member of the group can decide matters such as where the purchase is to be made. The other members of the group can then either decide to participate in the group purchase or can decide not to participate in the group purchase.

One member can be designated to make the purchase on behalf of the group. The person who is designated to make the purchase on behalf of the group can be referred to herein as the organizer or purchasing user. The other members of the group can be referred to herein as users, contributing users, or group members. All of the members of the group, e.g., the contributing users and the purchasing user, can interact with one another to make decisions regarding the purchase. Alternatively, the purchasing user can make all or many of the decisions regarding the purchase and then the contributing users can decide whether or not to participate.

The purchasing user can be the member who initiates the group purchase process and/or the person who organizes the group purchase. A contributing user can initiate the purchase process and then let another user organize the purchasing process and/or make the purchase. Thus, one member of the group can initiate the purchase process and another member of the group can make the purchase.

Money can be transferred from accounts of the contributing users to an account of the purchasing user and the purchasing user can make the purchase. For example, all of the members of the group can use a common payment provider, such as Paypal, Inc. Each of the contributing users can authorized the payment provider to transfer money from their account into the account of the purchasing user. The purchasing user can then use the transferred money, as well as money of the purchasing user, to make the purchase. Thus, the cost of the purchase can be shared among the members of the group.

The purchasing user can contribute to the purchase. Alternatively, the purchasing user can not contribute to the purchase. The contributions of the contributing users and the purchasing user can be equal. The contributions of the contributing users and the purchasing user can be unequal. The contributions of the contributing users can be unequal. The group can decide, such as by voting, whether all members of the group must contribute the same amount of money.

According to one or more embodiments, the group can vote upon the purchase. That is, each member of the group can vote upon what to purchase, where to make the purchase, and/or what to pay for the purchase. Voting can be done by proxy. Each member can participate in decisions regarding the purchase to any desired degree.

For example some members of the group may participate in all decisions regarding the purchase and other members of the group may participate only in the final decision regarding whether or not to make the purchase. Each member of the group can designate one or more other persons of the group to act on their behalf regarding the decisions or any subset of the decisions.

According to one or more embodiments, a consensus can be required for any or all decisions regarding the purchase. Thus, the group purchase will not be done unless all members of the group concur regarding such decisions.

Each member of the group can use a member profile to define parameters regarding their desire to participate in group purchases and regarding any designations of other persons to act on their behalf regarding any of the decisions associated with group purchases. The member profile can be a member profile of the social network, the payment provider, or any other website or service (such as a website of an online retailer).

Each member of the group can previously agree to aspects, features, or terms of a group purchase. Such previous agreement can be performed and recorded in the member profile. For example, a member of the group can agree to participate in all purchases for gifts for specified individuals, can agree to participate in all purchases for gifts that cost below a pre-defined amount of money, and/or can agree to participate in all purchases for gifts which occur within thirty days of a specified individual's birthday.

The purchase can be made from a retailer. The retailer can be an online retailer or a brick and mortar retailer. The retailer can be a brick and mortar retailer that also is an online retailer. The purchase can be for a product, a service, a combination of a product and a service, or anything else.

Online retailers can facilitate group purchase by offering discounts, premiums, free shipping, and the like for such purchases. Online retailers can facilitate group purchase by accepting payment from multiple parties. Online retailers can facilitate group purchase by accepting payment from multiple payment providers.

The launch of Facebook Connect allowed users to “connect” their Facebook identity and friends to any site. This enabled many websites to leverage the power of Facebook's social context on existing shopping sites. The Facebook platform features seamless, one-click authentication, Facebook friend account linking, distribution back into Facebook streams, and the full power of the Facebook REST-like API and FQL. Utilizing Facebook Connect for authentication has proven to dramatically increase site exposure and new user registrations.

Rather than a social network, email can be used to facilitate communication between the group members. Any combination of email and a social network can be used to facilitate communication between the group members.

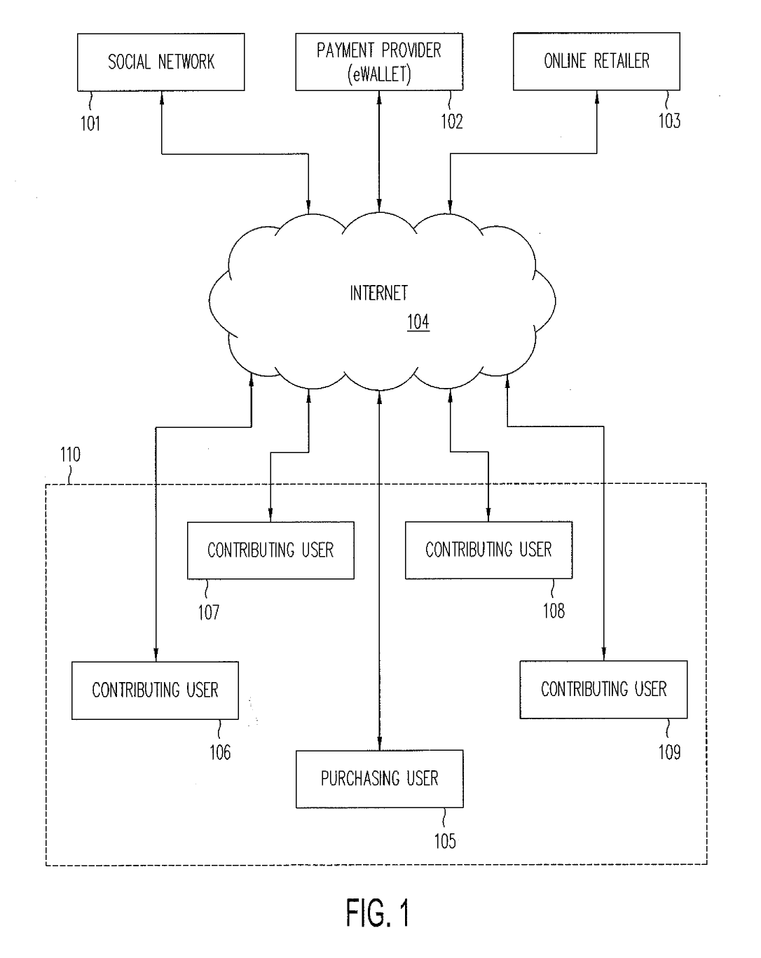

FIG. 1 is a block diagram showing a group purchase system, in accordance with one or more embodiments. The group purchase system can include a social network 101, a payment provider 102, and an online retailer 103. The social network 101, the payment provider 102, and the online retailer 103 can be in communication with one another by a network, such as the Internet 104. The social network 101, the payment provider 102, and the online retailer 103 can be in communication with one another via a cellular telephone system or the like.

The social network 101 can be an Internet based social network such as Facebook, Twitter, or Myspace. The social network 101 can be any network, club, organization, or other entity that facilitates communication among members, such as group members desiring to make a group purchase.

The payment provider 102 can be an Internet based payment provider such as Paypal, Inc. The payment provider 102 can be a credit card company, a bank, a financial institution, or other business or entity that facilitates payment by an individual to a merchant for a purchase. The payment provider 102 can facilitate money transfers among members of the payment provider 102. In this manner, members of a group who want to participate in a group purchase can transfer money to one member of the group who can then make a purchase on behalf of the group.

The online retailer 103 can be any provider of goods or services. The online retailer 103 is shown by way of example only and not by way of limitation. Alternatively, a brick and mortar retailer or other seller of goods or services can be used in the practice of the disclosed system and method.

A purchasing user 105 and a plurality of contributing users 106-109 can define a group 110. The purchasing user 105 and the plurality of contributing users 106-109 can be members of the same social network 101 and can use the same payment provider 102. Thus, the members of the group 110 can communicate with one another via the social network 101 and the members of the group 110 can transfer money to one another via the payment provider 102.

For example, some members of the group 110 can transfer money into an ewallet of the payment provider 102. The ewallet of the payment provider 102 can be or can represent an account of the user receiving the money. The money can be transferred from ewallets of the transferring members of the group 110 or can be transferred in any other manner.

There can be any number of contributing users 106-109. Generally there will be one purchasing user 105. However, a plurality of people may share the duties of the purchasing user 105. Thus, there can be more than one purchasing user 105 for a particular group purchase.

The purchasing user 105 can be that member of the group 110 that makes a purchase and can make the purchase on behalf of the group. The contributing users 106-109 can be those members of the group 110 that contribute money for the purchase. The purchasing user 105 can contribute money for the purchase. The purchasing user 105 can be required to contribute money for the purchase. Alternatively, the purchasing user 105 is not required to contribute money for the purchase.

The purchasing user 105 and the plurality of contributing users 106-109 can communicate with one another in person or via telephone, email, text messages, tweets, and/or the social network 101. The purchasing user 105 and the plurality of contributing users 106-109 can communicate with one another via any method or combination of methods.

The purchasing user 105 and the plurality of contributing users 106-109 can be family member, friends, co-workers, or any combination thereof. The purchasing user 105 and the plurality of contributing users 106-109 can be members of the same church, club, other organization (such as a social network), or any combination thereof. The purchasing user 105 and the plurality of contributing users 106-109 can be defined in any desired manner.

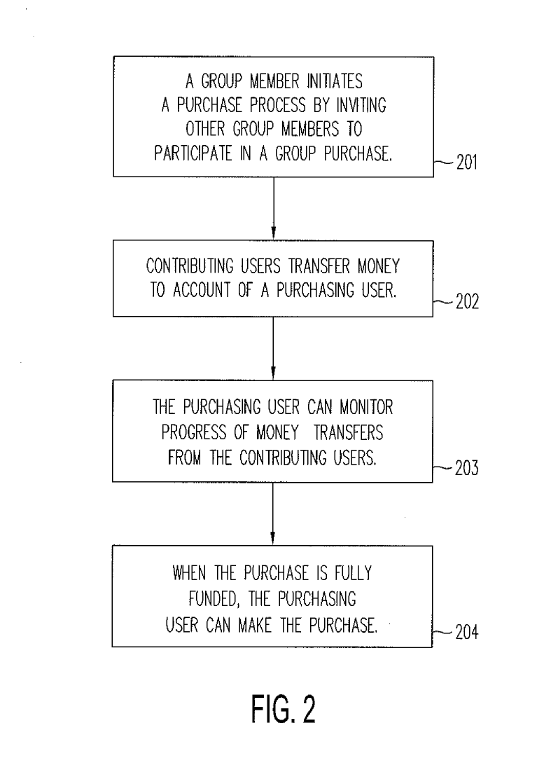

FIG. 2 is a flow chart showing an overview of operation of the group purchase system, in accordance with one or more embodiments. A group member, e.g., the purchasing user 105 or one of the plurality of contributing users 106-109, can initiate a purchase process by inviting other group members to participate in a group purchase, as shown in step 201.

The contributing users 106-109 can transfer money to an account of the purchasing user 105, as shown in step 202. The transfer of money can be facilitated by the social network 101 and/or the payment provider 102. The transfer of money can be facilitated by the cooperation of the social network 101 with the payment provider 102 or by any other means or entity.

The purchasing user 105 can monitor the progress of the money transfer, as shown in step 203. If the money transfer proceeds more slowly than anticipated, the purchasing user 105 can re-define terms of the group purchase. For example, a lower priced item can be purchased or more contributing users 106-109 can be sought so as to lower the necessary contribution amount of each of the contributing users 106-109.

When the purchase is fully funded, e.g., sufficient contributions have been made by the contributing users 106-109 and/or the purchasing user 105, the purchasing user 105 can make the purchase, as shown in step 204. The payment server 102 can authorize the purchase transaction for the purchasing user 105 once sufficient money has been transferred to the account of the purchasing user 105 to make the purchase.

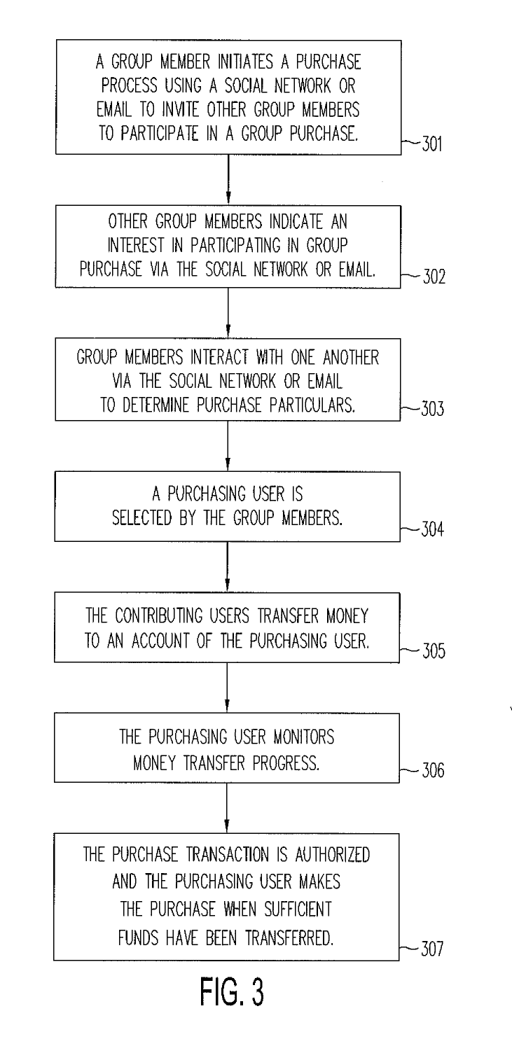

FIG. 3 is a flow chart showing more detailed operation of the group purchase system, in accordance with one or more embodiments. A group member, e.g., the purchasing user 105, can initiate a purchase using a social network or using email to invite other group members to participate in a group purchase, as shown in step 301. The other group members, e.g., the contributing users 106-109, can indicate an interest in participating in the group purchase, as shown in step 302. For example, the other group members can indicated an interest in participating in the group purchase via email, text messages, tweets, the social network 101, or by accessing a web page via a predefined uniform resource locater (URL).

Optionally, the group members can interact with one another to determine particulars of the purchase transaction, as shown in step 303. For example, the group members can interact with one another to determine who the group members are, whether or not each of the group members must contribute equally, the amounts of the contributions, when the contributions are to be made, and the like. The group members can interact with one another via email, text messages, tweets, the social network 101, or by accessing the web page.

A purchasing user 105 can be selected from among the group members, as shown in step 304. The purchasing user 105 can be selected by the group members, such as by nomination, vote, consensus, or any other means. The purchasing user 105 can be the group member who initiated the purchase process and can be the organizer (who organizes and manages the group process, for example). The purchasing user 105 can be any person.

The contributing users 106-109 can transfer money into the account of the purchasing user 105, as shown in step 305. In this manner, the purchasing user 105 can have sufficient funds to complete the purchase transaction. Thus, only one person needs to be involved in the purchase transaction. In this manner, the purchase process is substantially simplified as compared to having multiple group members participate in the purchase.

The purchasing user 105 can monitor the money transfers from the contributing users 106-109 into the account of the purchasing user 105, as shown in step 306. The purchasing user 105 can monitor the money transfers via email, text messages, tweets, the social network 101, or the web page. The purchasing user 105 can monitor the money transfers via a computer display such as a dashboard, as discussed below.

The purchase transaction can be authorized by the payment provider 102 and the purchasing user 105 can make the purchase when sufficient funds have been transferred into the account of the purchasing user 105, as shown in step 307.

An embodiment is discussed below wherein the purchase is a gift. The discussion of the purchase as a gift is by way of example only, and not by way of limitation. The purchase can be for any purpose and need not be for a gift.

A group gifting plugin can be provided. The group gifting plugin can be a portable technology that allows retailers to integrate the group purchasing transaction process into their product web pages by assimilating an external application programming interface (API) and embedding the external API into their website's code.

The integration process can include selecting the location for the group gifting plugin on retailer's product web page. Another aspect can be an interface customization to fit the plugin graphic user interface to retailer's requirements. Another aspect can include placing customized code to display the group gifting plugin next to the product details page on the ecommerce website.

The group gifting process used on the plugin can comprise four main parts. First, the group gifting process used on a plugin can comprise a part which can be used by the person who initiates the group purchase to invite the gift-giving participants or group members to participate, such as either through social networks or email invitations.

Second, the group gifting process used on the plugin can comprise a part that can be used by group members, e.g., gift-givers to contribute money to the group purchase wherein the money can be accumulated in an account, ewallet, or the like. The ewallet can be an electronic third party secured account for accumulating funds. For example, the ewallet can be provided online, such as by a payment provider.

Third, the group gifting process used on the plugin can comprise a part wherein the initiator of the group purchase or any other person, e.g., a group member, can track and manage the group purchase process. The group purchase process can be tracked and manage from an online dashboard, for example.

Fourth, the group gifting process used on the plugin can comprise a part via which, when the group purchase is fully funded, the initiator or another person, e.g., a purchasing user, can purchase the gift with the collected money and have the gift sent to the recipient. The plugin can enable retailers to integrate a group gifting process into their product pages in a seamless manner. This can be done without requiring significant technical effort by the retailer.

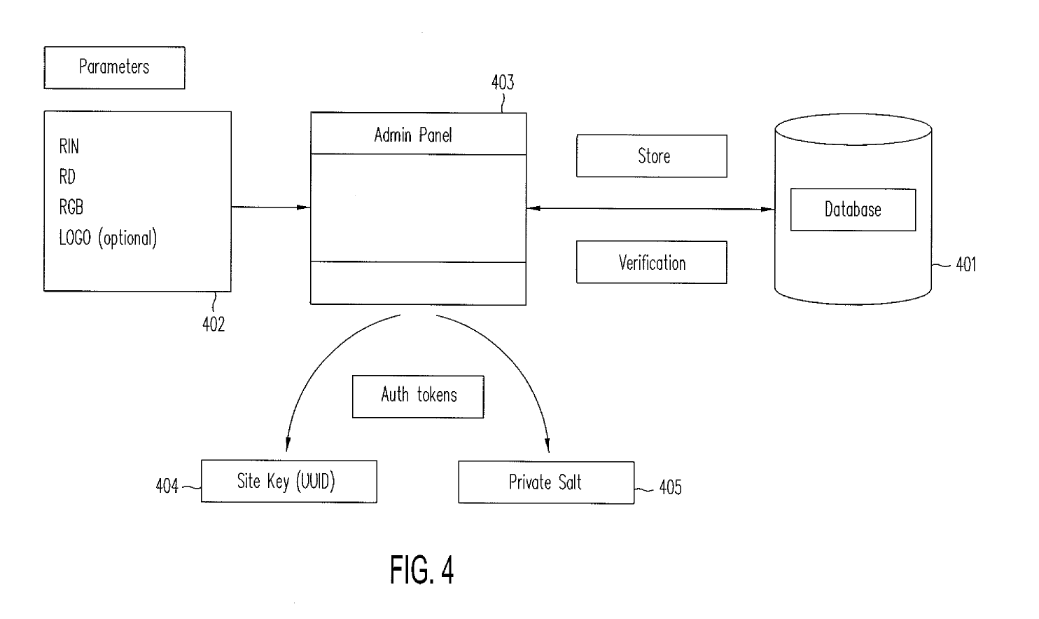

FIG. 4 is a block diagram showing a registration/installation process that can be performed by the retailer, in accordance with one or more embodiments. Registration can be a preliminary step required prior to the installation of the plugin on the retailer website. The registration can be performed either manually or via a site registration portal.

Registration can accomplish two goals. First, registration can define minimal settings required to allow the retailer to authenticate with a plugin server. Second, registration can allow the retailer to customize the plugin graphic user interface, such as to match a color scheme and logo of the retailer.

A database 401 can be used to store customized configuration parameters 402 regarding settings provided by the retailer, in addition to unique identification parameters, provided in a secured manner for each retailer. The retailer can be required to provide the parameters 402. The parameters 402 can be provided, stored, and verified by an admin panel 403.

The parameters 402 can include a retailer identification name (RIN), e.g., “My Store”; a retailer domain (RN), e.g. www.mystore.com; and Graphic User Interface settings. The Graphic User Interface settings can include a plugin window color scheme (RGB) and an optional logo.

Upon registration, two unique tokens can be generated for the retailer to authenticate. The two unique tokens can be a site key 404 and a private salt 405. The site key 404 can be a public unique user identifier (UUID) that is originated on the retailer domain and passed on upon each request to the plugin. The private salt 405 can be optional and can be used to generate hash values when verifying product detail, as discussed below.

The database 401 can be a centric database. The database 401 can hold the registration information, e.g., parameters 402, for all participating retailers. After a brief verification process, the tokens, e.g., the site key 404 and the private salt 405, can be returned to the retailer to complete his registration.

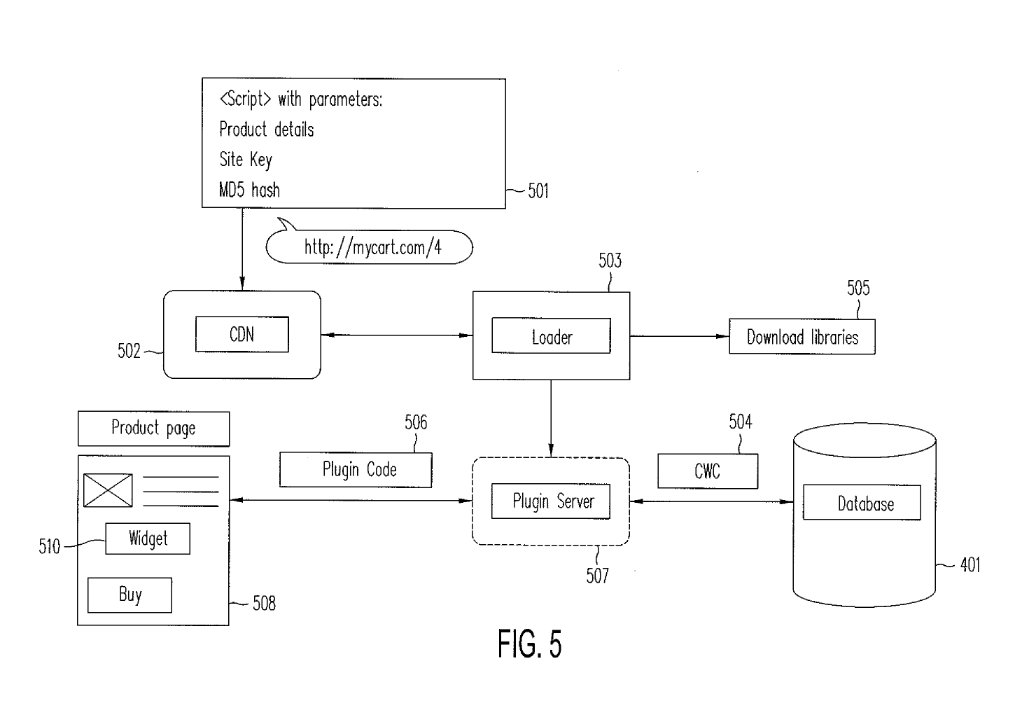

FIG. 5 shows an installation and loading process, in accordance with one or more embodiments. Upon registration, the retailer can receive a JavaScript code snippet to embed within the product page. This embeddable code template can comprise static text and dynamic parameters 501 that can be passed by the retailer to each page. These parameters 501 can include product details, a site key, and an MD5 hash, for example. The product details can include a product description, price, and any variations of the product that are available, and any other desired information.

The site key can be matched against the retailer domain. This can be done to ensure that the code originated from the retailer. An optional MD5 hash can be formed from the private secret salt provided at the registration process and can be concatenated with the product parameters.

The code can activate downloading of a JavaScript loader 503 from a content delivery network (CDN) 502 that can initialize the page environment for the plugin operation in two steps. The loader 503 can be stored in download libraries 505. In a first step, the code can ensure that all dependent JavaScript libraries have been loaded. In a second step, the code can load plugin code 506 together with the customized window configuration (CWC) 504 of the specific site. The plugin code 506 can be loaded from a plugin server 507 to a product page 508.

A widget 510 can be placed on the merchant's product page proximate a product being sold. The widget 510 can be defined by the plugin code 506. The widget 510 can be a link that directs a potential customer to web pages that facilitate a group purchase. The widget 510 can be placed according to a tag defined by the retailer on the product page and can be characterized according to the registration (setup) process.

When a user visits a product page 508 on the retailer website, the widget 510 can be displayed. The widget 510 can show the amount to be collected and how it will be divided between participants. For example, the widget 510 can show such information when the cursor is place on the widget 510. This can be a default state of the widget 510. Other states of the widget 510 can be defined, as discussed below. The widget 510 can display a call to action button which, when clicked, can open a participant invitation overlay.

Participants or potential contributing users can be invited to participate in the group purchase. For example, a group purchase participant invitation overlay can have two segments. In a first segment, a surrounding frame can be invoked by JavaScript and themed according to the setup process performed by the retailer. An iframe, which can receive information, can be passed by the plugin via JavaScript as GET parameters.

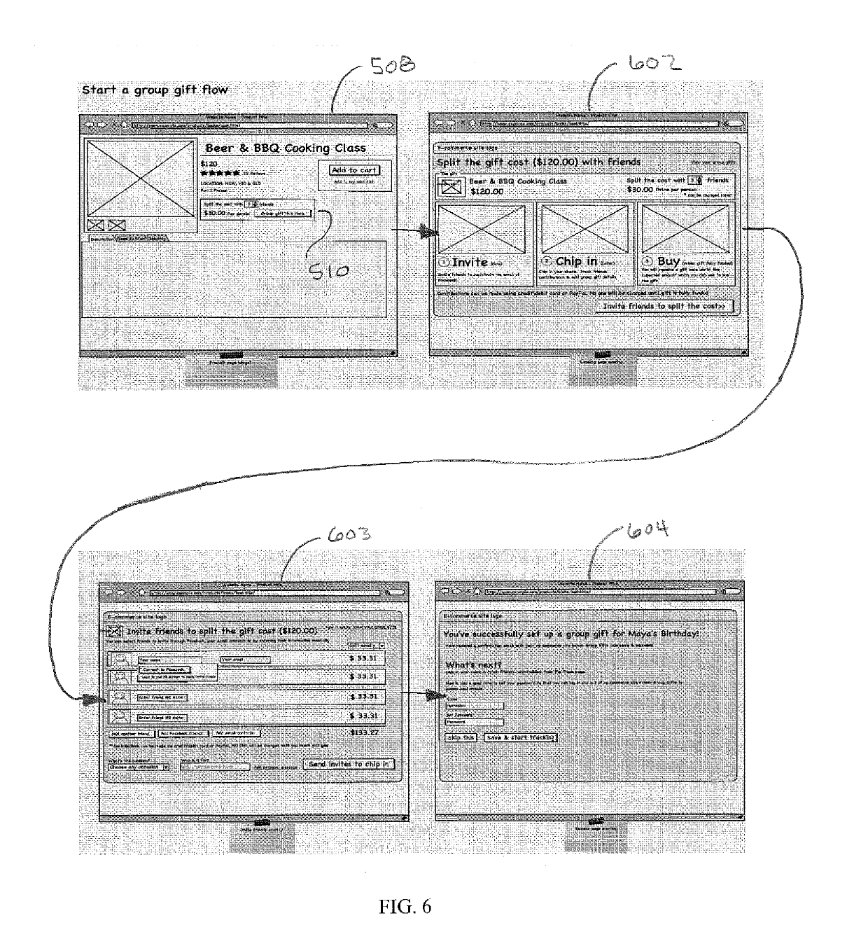

FIG. 6 is a series of screens showing process flow for starting a group purchase transaction, in accordance with one or more embodiments. The widget 510 on the product web page 508 can be used to initiate the group purchase process. The participant invitation overlay web page 602 can allow the organizer to invite other participants. For example, the other participants can be invited by manually entering participant's name, with autocomplete suggestions from Facebook friends, and email contacts.

As a further example, the user can manually type the name of the user's invitees on a row based table list. When typing, an autocomplete feature can allow the user to choose contacts from either Facebook or any mail client that the user has previously connected to, using Open Auth.

Multiple friends can be imported from Facebook using Facebook Graph API, such as by using FQL queries. A user's friends list can be imported and can allow the user to select participants from the list while showing their names and photos.

Importing multiple contacts from mail clients (gmail, yahoo mail, hotmail) can be performed using open authentication. Using open authentication enables the user to authenticate with the user's mail clients and import invitees from the user's contact lists.

Each invitee can have a name and a Facebook account and/or an email account. Invitees that have been selected from Facebook, can be sent an invitation using the Facebook Request Dialog. Each invitee can receive a group gift request, with a link that will forward them to the group gift on the retailer site.

Invitees that have been selected from email contacts can be sent a personal email with a unique link that will identify them when arriving at the group gift page. The participant invitation overlay 602 can facilitate a group gift in a one step process. After sending the invites, a cookie can be stored to identify the organizer of the gift in later visit and a passive registration process will be initiated.

According to the passive registration process, the organizer will be sent a unique activation link that will enable the organizer to register when visiting the group gift page at a later stage. The registration can be obtained either through common ‘sign in’ providers (such as Facebook Connect, Google single sign on), or the registration can be obtained through the use of email and a password.

The manner in which contributions are to be split among contributing users can be entered on a split web page 603. A successful setup web page 604 can be display one a successful set up of the group purchase has been accomplished.

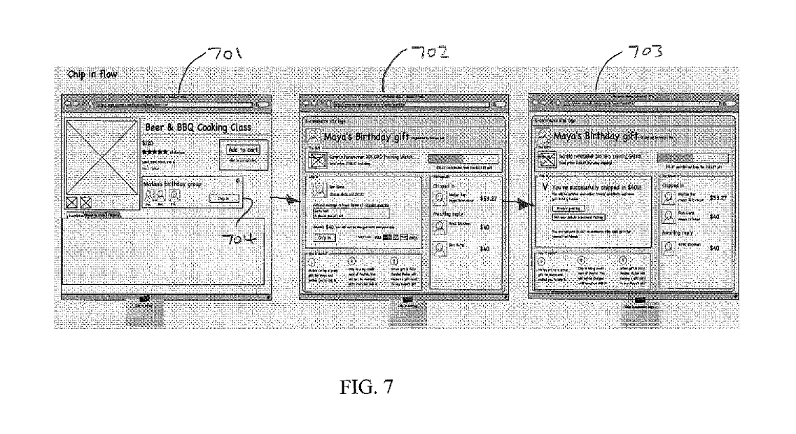

FIG. 7 is a series of screens showing process flow for group member chipping in to a group purchase transaction, in accordance with one or more embodiments. Chip in can be defined as the process by which invitees or contributing users make contributions of money. Contributing users can reach a contribution page 701 either by an email link or a Facebook Request. The contribution page 701 can have a chip in link 704.

Each invitation method can have a unique identification mechanism that helps the plugin to identify the invitee without requiring her to login. When Facebook Requests are sent, the Facebook IDs of invitees can be stored in the database 401 (FIGS. 4 and 5). When an invitee receives the request, the invitee can be required to authorize it.

This process can trigger a redirect to the contribution page 701 on the retailer website. Additional Facebook parameters can be passed as GET parameters (such as Facebook ID). Matching a Facebook ID parameter to the IDs that were stored in the database can identify the invitee.

When email invitations are sent, an arbitrary unique token can be generated and passed through the invitation link embedded in the email. This token can stored in the database 401 and can be matched against a token when the invitee lands on the contribution page.

A cookie can be stored for the contributor to identify the contributor on future visits to the product page 601. After contribution towards a group gift, the product page widget 510 can display information regarding the amount contributed and general information about the gift.

A contribution overlay 702 can be opened automatically on the retailer website when the invitee lands on the page. This can be done by passing a unique URL parameter. The unique URL parameter can trigger an event on the JavaScript code embedded in the product page.

Contributions can be made via the payment provider 102 (FIG. 1). Contributions can be made via PayPal Preapproval API, for example. Contributing users can pre-approve the payment of a predetermined amount of money when the gift funding is still being collected. When committing to pay, preapproval pay keys can be being collected and stored in a database, such as database 401, so that contributors are not charged immediately, but rather are only charge after the entire gift goal is met. Thus, contributing users are only charged for the group purchase if enough money is contributed to make the group purchase.

A closure chapter or page 703 can describe the money capture process in further detail. In addition to the payment, contributors can optionally leave a personal message that can be displayed later both on the contribution page next to their contribution, and on a group greeting.

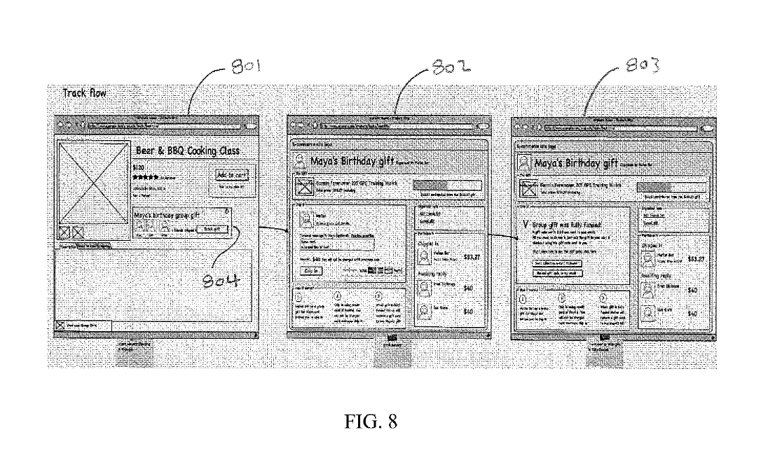

FIG. 8 is a series of screens showing process flow for tracking a group purchase transaction, in accordance with one or more embodiments. The organizer can track the progress of the group purchase and can manage the group purchase through the widget 804 on the product page 801. After the gift has been created and invitations have been sent, the widget 804 can display general information about the progress of the gift.

Clicking on the widget 804 can open a tracking overlay, allowing the organizer to contact invitees or cancel the gift, e.g., cancel the group purchase process. Thus, the organizer sends a message to the invitees, reminding them to contribute to the gift. The organizer can cancel all pre-authorized payments, cancel the gift and notify all contributors.

The tracking overlay 802 can be similar to the contribution overlay 702. The tracking overlay 802 can differ with respect to the contribution overlay 702 in the actions that can be performed via the tracking overlay 802.

A status page 803 can display a status for the group purchase. The status can contain the information displayed and the operations that can be performed. An active status can be the default for group purchase that have been created. A fully funded status can indicate that a group purchase has reached the funding goal. A completed status can be reached after a gift has been fully funded and the organizer finalized the group purchase.

Once the organizer has finalized the group purchase, the organizer can receive a gift certificate for the purchased item. This action will trigger a transition from fully funded state to a completed state. Either a gift certificate can be provided or the gift can be shipped to the organizer, the recipient of the gift, or any other specified person. A canceled status can indicate that the group purchase has been cancelled, such as by the organizer.

Generally, the gift can only be cancelled prior to the group purchase being in a completed status. Optionally, the group purchase can be cancelled at any time. The cancellation can trigger an email, for example, to the invitees announcing the cancellation and letting the invitees know that they will not be charged.

Thus, once the gift has been fully funded, the organizer can choose to finalize the gift and trigger an event which will capture the money from the contributors and issue a gift certificate, facilitate a money transfer, or purchase the gift. The gift certificate or money can facilitate the purchase of the gift, such as by the organizer, the gift recipient, or anyone else, from the merchant website.

When the group purchase process is complete, preapproved payments that were made by the contributors can be captured via the PayPal Pay API. This operation can transfer money from the contributors account to The Gifts Project PayPal account, for example.

The organizer can choose to receive the collected amount by money transfer, or as a gift certificate for the retailer website. A gift certificate can be issued by a gift certificate bank or by a gift certificate API. When a gift certificate bank issues the gift certificate, a list of gift certificates can be stored for the entire range of gifts offered by the retailer, so that when the gift goal is reached, a gift certificate for the specific amount that has been collected will be issued.

When the gift certificate is issued by the gift certificate API, such as a gift certificate API of the merchant, then the gift certificate can be issued when the gift goal is reached. A dynamic allocation of gift certificates in a value of the collected amount can be generated specifically for the organizer.

By combining personal greetings that have been collected through the contribution process, a group greeting can be generated. A template can be displayed that corresponds to the gift occasion and is graphical by nature. The contributors' avatars can be displayed on the greeting alongside their personal greetings.

The plugin can comprise a server side installation and a client side widget. The server software can be developed using Ruby on Rails, for example.

The plugin server can be deployed on Amazon Web Services EC2 instances, according to the following layout. Application servers can comprise Linux servers running unicorn rails web servers over nginx. A haproxy load balancer can control the server stack. The database can be deployed on a master/slave configuration, running MySQL 5.5, for example, a utility server can runs background tasks, such as: reminders, maintenance routines, and crons, for example. The client side widget 510 can be developed using JavaScript and JQuery library, for example.

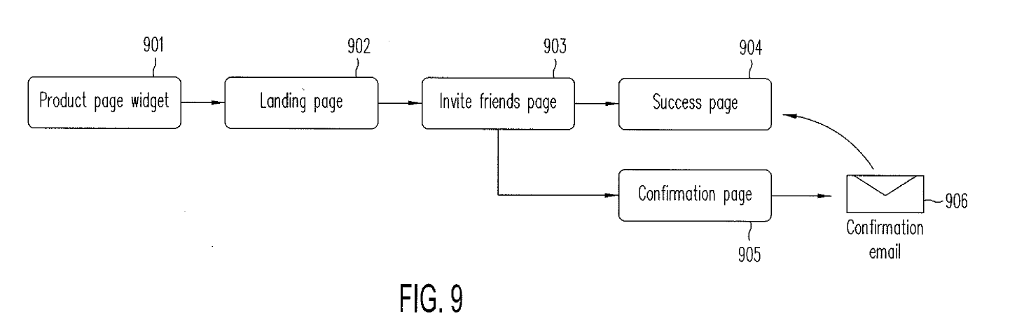

Referring now to FIGS. 9-44, further examples of a group purchase process for the purchase of a gift are provided, in accordance with one or more embodiments. These figures show group purchase flows for inviting friends, chipping in, tracking contributions, and purchasing the gift. Again, the group purchase can be for any purpose and is not limited to being a group purchase for a gift.

FIG. 9 is a flow chart showing process flow for inviting group members to participate in a group purchase transaction, in accordance with one or more embodiments. The invite friends flow begins with a product page widget 901 and flows to a landing page 902, an invite friends page 903, a success page 904, a confirmation page 905, and a confirmation email 906, as discussed below.

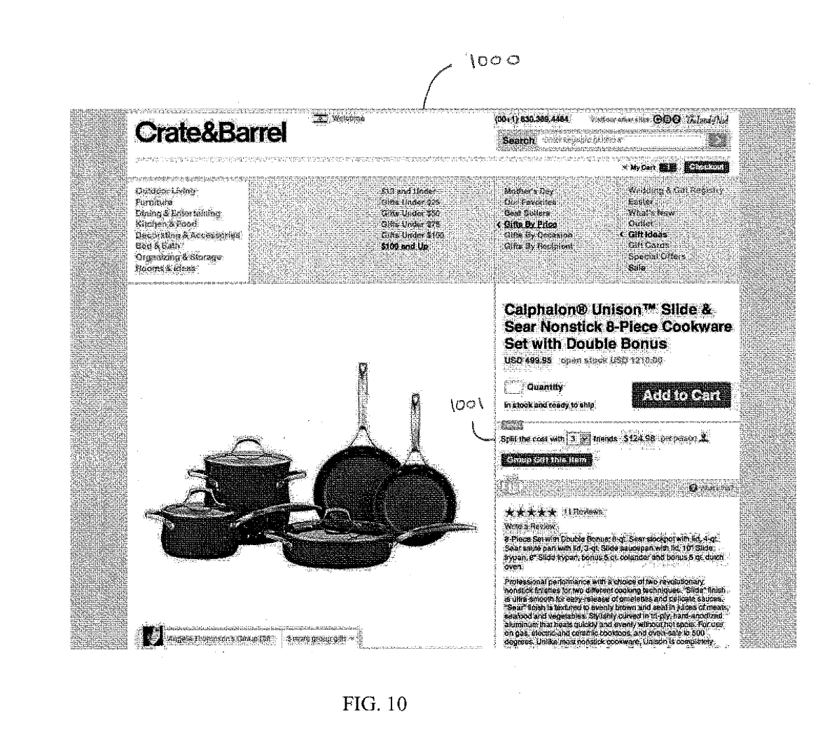

FIG. 10 is a screen showing a product page 1000 having a widget 1001, in accordance with one or more embodiments. The widget enables the customer to split the cost of a specific item, e.g., the item shown on the product page. Using the widget 1001, the customer can calculate the price per person by selecting the number of friends that will participate in buying the gift. The price per person is calculated by dividing the product price equally among participants. Other methods for determining the price that each person pays can be used.

For example, each person can pay a different amount. The amounts paid by each person can be agreed to by each individual contributor. The amounts paid by each person can be agreed to by the group, such as by voting or consensus. The amounts paid by each person can be determined in any desired manner.

The customer can start a group purchase by clicking on the “Group Gift this item” button of the widget 1001. Clicking on this button can open the Invite Friends page (an overlay on top of the product page). The customer can start the group purchase by right clicking anywhere on the web page 1000, such as over the product, to open a drop down menu that includes the group purchase option.

When a customer clicks on the “What's this?” link of the widget 1001, a tooltip can be displayed along with a short explanation of how group gifting works with The Gifts Project Plugin. A help menu or system can also be provided.

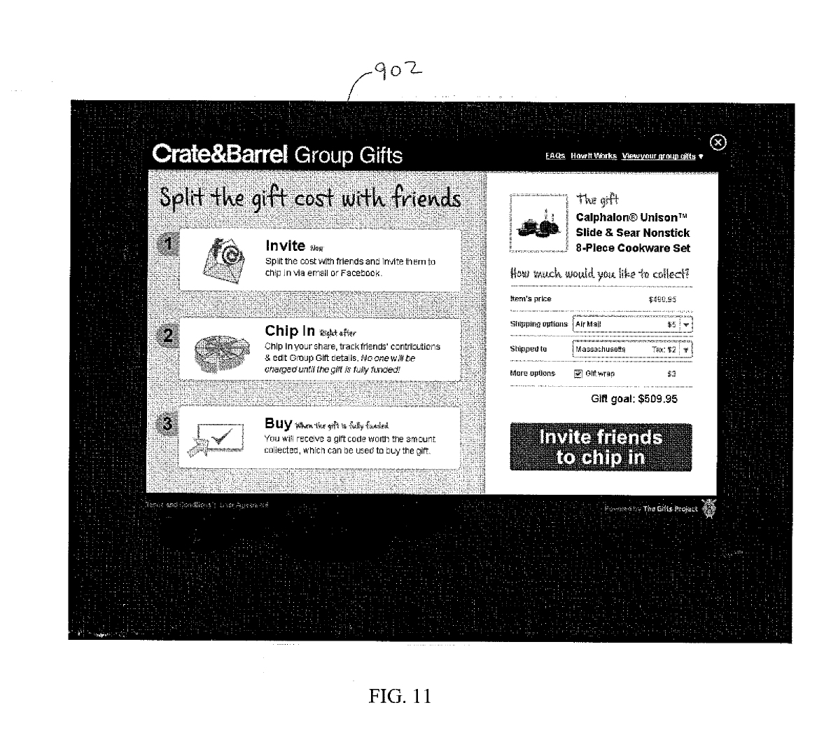

FIG. 11 is a screen showing the landing page 902, in accordance with one or more embodiments. The main purpose of the landing page 902 is to briefly explain how online group gifting works using the TGP plugin. The processes of inviting group members to participate in the group purchase, chipping in, and buy the gift can be explained on the landing page 902.

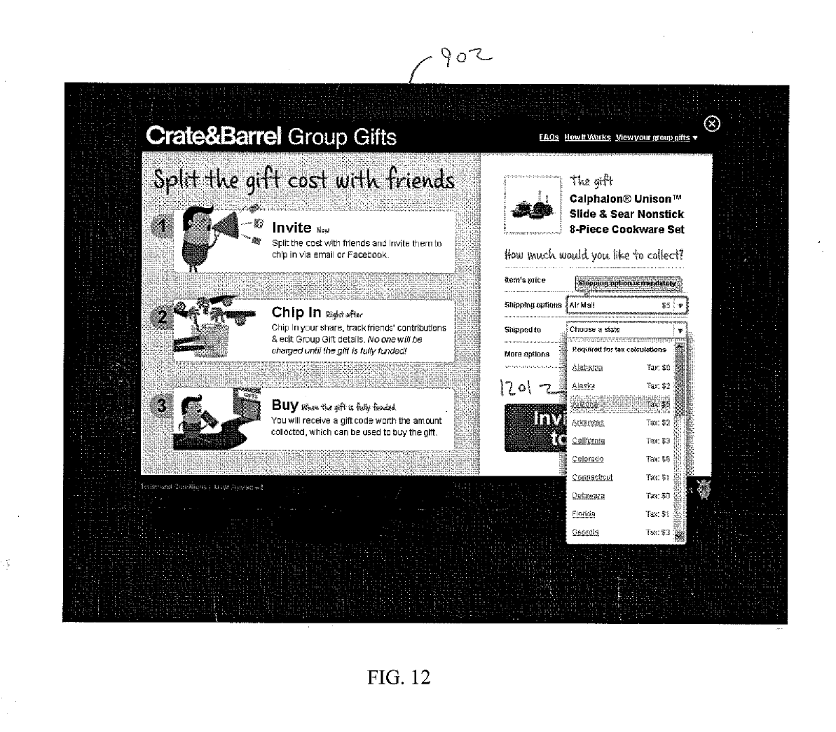

FIG. 12 is a screen showing the landing page 902 including mandatory data as defined by a hosting e-commerce site, in accordance with one or more embodiments. Additional cost, such as shipping and taxes can be determined using a drop down menu 1201. The organizer can calculate an accurate gift goal by adding additional relevant fees to the total cost of the item. This part is of the group purchase system can be fully customizable and can include any additional costs that the hosting e-commerce site finds suitable to display on this page.

Adding additional costs to the amount to be shared can be optional. Optionally, the organizer or anyone else can pay any remaining amount, e.g., the additional costs, in case the collected amount does not cover the total amount of the purchase during the checkout flow.

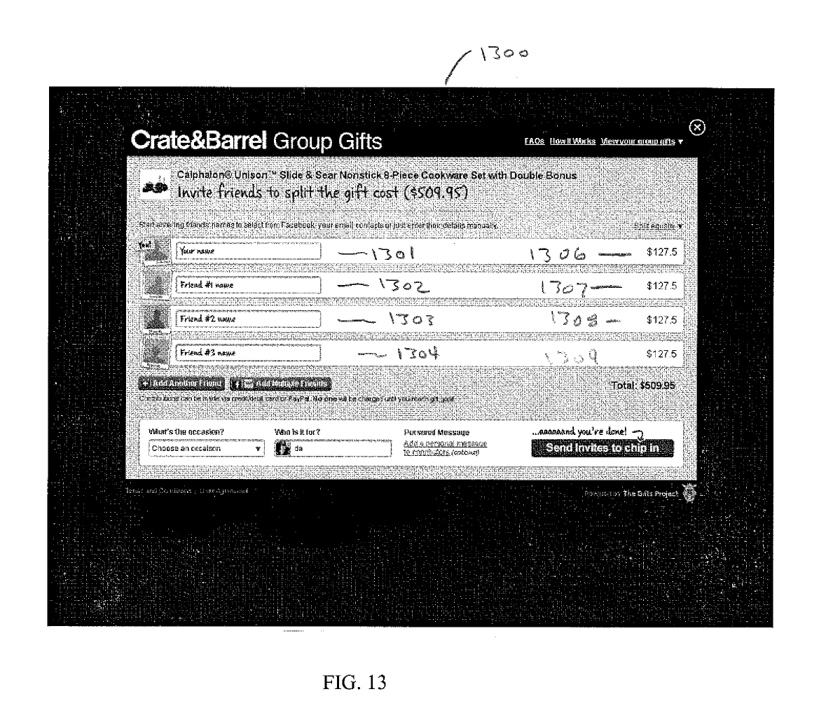

FIG. 13 is a screen showing an invite friends page 1300 for inviting group members to participate in the group purchase transaction, in accordance with one or more embodiments. The organizer can invite friends or group members to participate in the group purchase using one or more of several methods. For example, the organizer can select friends from Facebook. Thus, an invited friend can receive a Facebook invitation. In order to invite friends from Facebook, the organizer can connect to Facebook. The organizer can enter an email address for the selected Facebook friend so that an email invitation can also be sent, in order to improve the chances that the friend will see and open the invitation.

The invite friends page 130 can have a plurality of name entry blanks 1301-1304 for contributor's names. The organizer can be a contributor and the organizer's name can be entered in the first name entry blank 1301.

The invite friends page 130 can have a plurality of contribution amount entry blanks 1306-1309 for contribution amounts. The organizer does not have to make a contribution and a zero (or no entry) can be provided for the organizer's contribution amount 1306.

The organizer can invite group members by select contacts from an email address book. For example, the organizer can select contacts from an email address book of Gmail, Yahoo or Windows Live. Selecting an email contact generally requires the user to connect to his email provider.

The organizer can invite group members by entering the friends' details manually (name and email address). Each friend can be invited using a different invitation method.

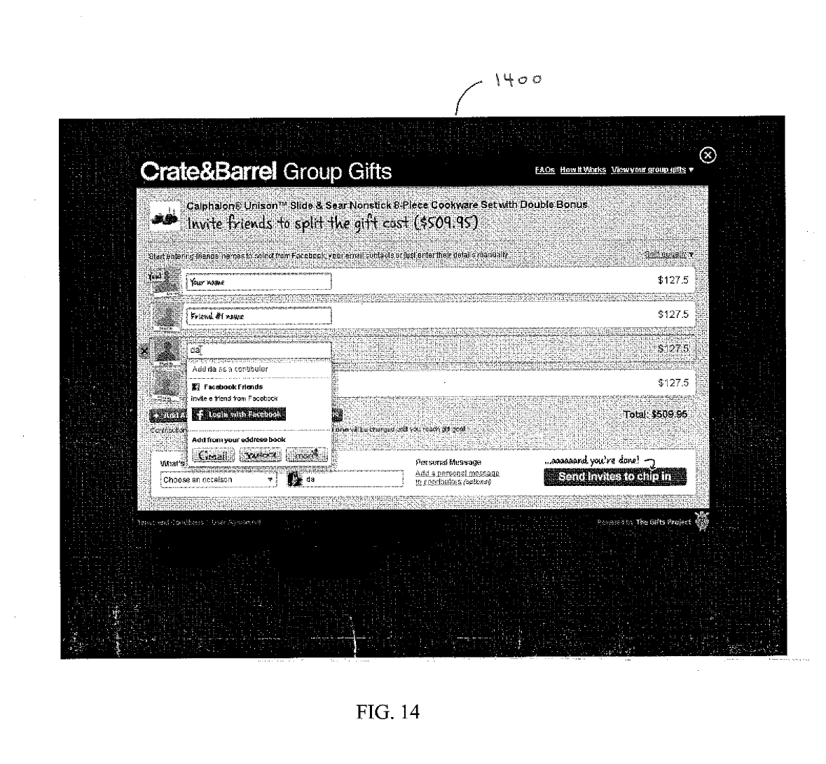

FIG. 14 is a screen showing a name entry page 1400. On the name entry page 1400, the names of each group member can be entered prior to the group purchase system connecting to a social network or email provider so as to communicate with the group members, in accordance with one or more embodiments.

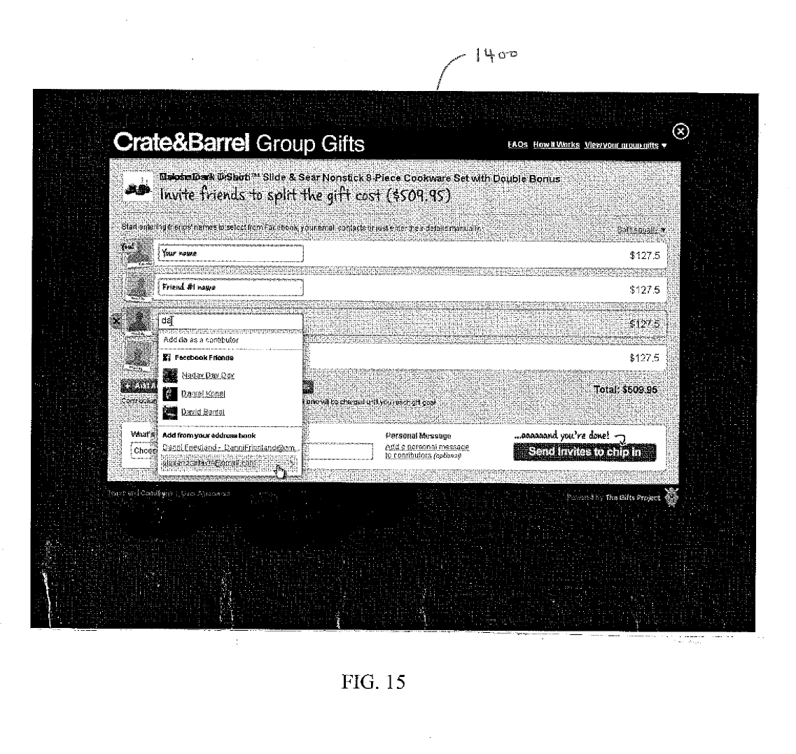

FIG. 15 is a screen showing the name entry page 1400 and showing entry of a group members name after connecting to a social network or email provider, in accordance with one or more embodiments. The organizer can add more friends to the name entry page 1400 by clicking on the “Add another friend” button. Clicking on this button will open a new empty row at the bottom of the table.

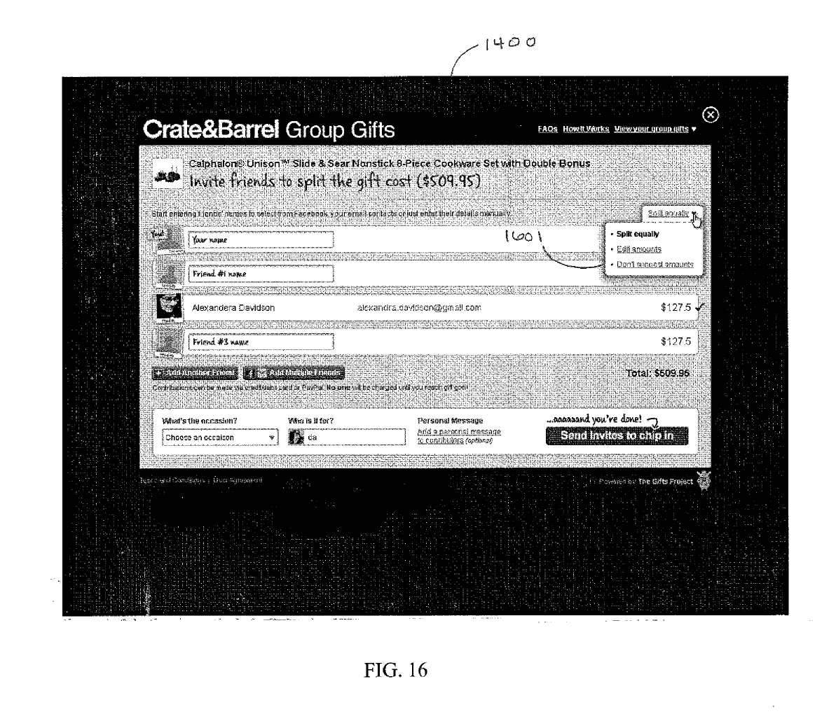

FIG. 16 is a screen showing the name entry page 1400 and showing selection of a method for splitting the cost of the item being purchased, in accordance with one or more embodiments. The organizer can have any desired number of option for splitting the cost amount the group members. For example, the organizer can have three options for splitting the cost among friends as selected using the amount drop down menu 1601 on top of the amounts column.

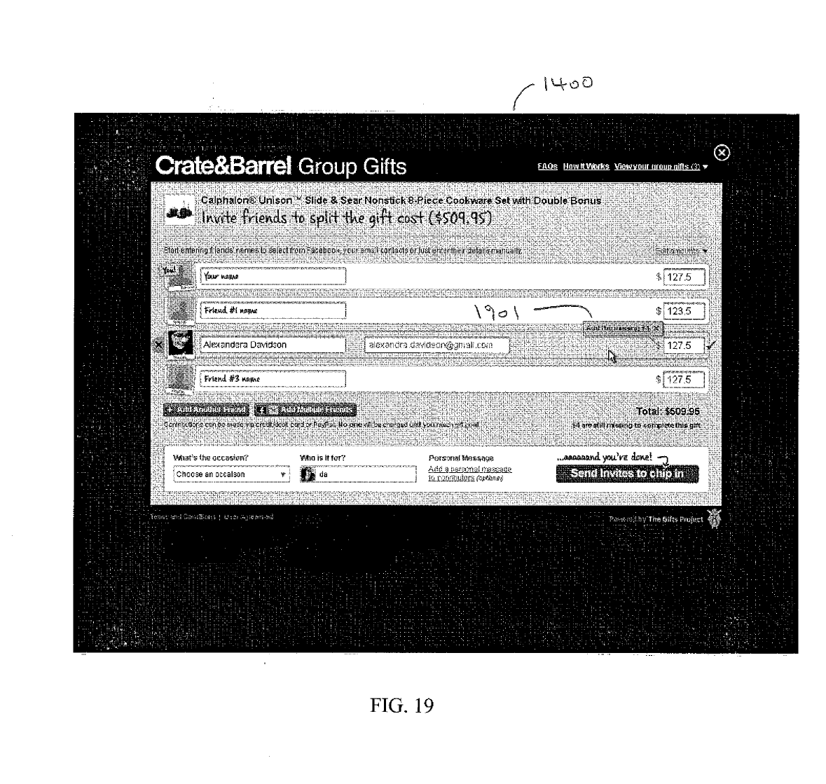

The contribution can be split equally. Splitting the contributions equally can be the default. Using this option will make the suggested amount fixed and the organizer can not be permitted to edit the amount for each invitee, as shown in FIG. 19 and discussed below. Each friend that is added or removed from the invite friends page will affect the amount suggested to friends.

Thus, each time a new friend is added or an existing friend is removed, the suggested amount can be recalculated. This can be done so that the suggested amount remains equally split among the number of friends in the table. Alternatively, the amount to be contributed can be reduced for added new friends. The can be done, for example, so as to entice further contributions.

An option can be provided to edit suggested amounts manually. The organizer can set a different suggested amount to each friend included on the invite friends page. If the gift goal is different than the sum of the suggested amounts in the table, the organizer can add the missing amount or remove the extra amount by clicking on the tooltip helper as shown in FIG. 16. This will assist the organizer in calculating how much needs to be added or subtracted.

An option can be provided to not suggest amounts to friends. The organizer can choose not to specify suggested amounts to friends and amounts will not be displayed in friends table. Each invitee will be able to chip in any amount that is less than the remaining balance.

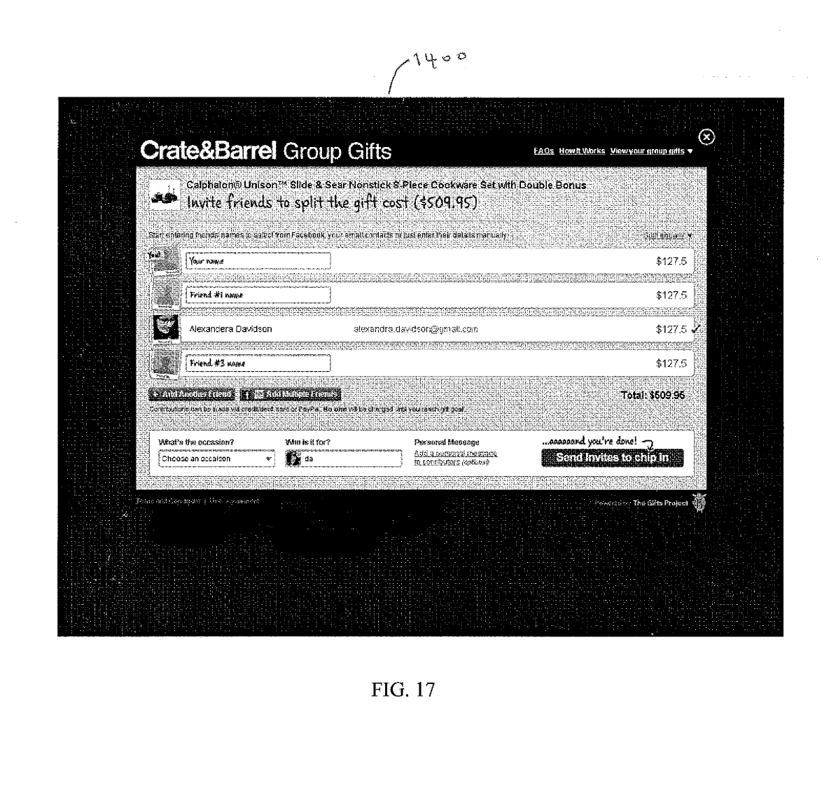

FIG. 17 is a screen showing the name entry page 1400 and showing the contributions of group members split equally, in accordance with one or more embodiments.

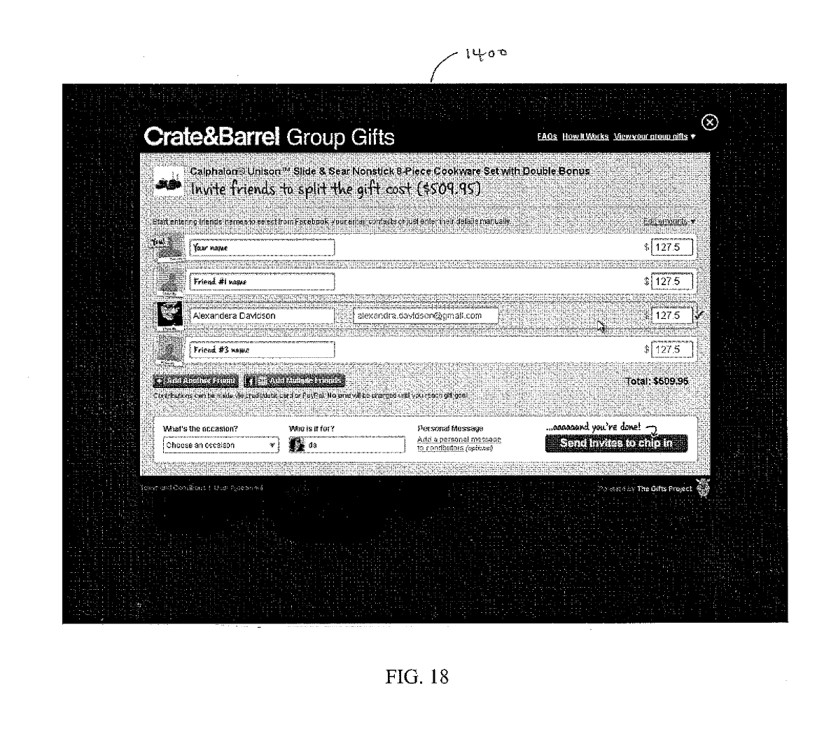

FIG. 18 is a screen showing the name entry page 1400 and showing manual editing of the amounts of the contributions, in accordance with one or more embodiments.

FIG. 19 is a screen showing the name entry page 1400 and showing a tooltip helper 1901 that can appear to help the organizer to add information such as a missing amount for a specified group member, in accordance with one or more embodiments.

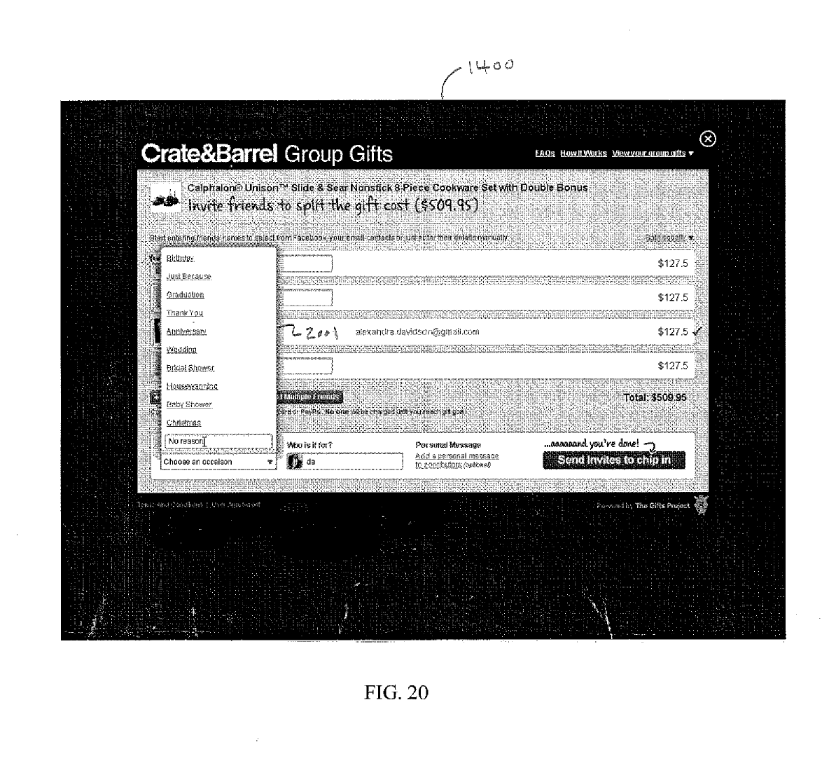

FIG. 20 is a screen showing the name entry page 1400 and showing selection of an occasion, in accordance with one or more embodiments. The organizer can select the occasion for the group gift. The organizer can select an occasion from a list of occasions or enter an occasion name manually in case the desire occasion is not on the list, as shown in FIG. 20. The group purchase, when used for purchasing a gift for example, can be personalized.

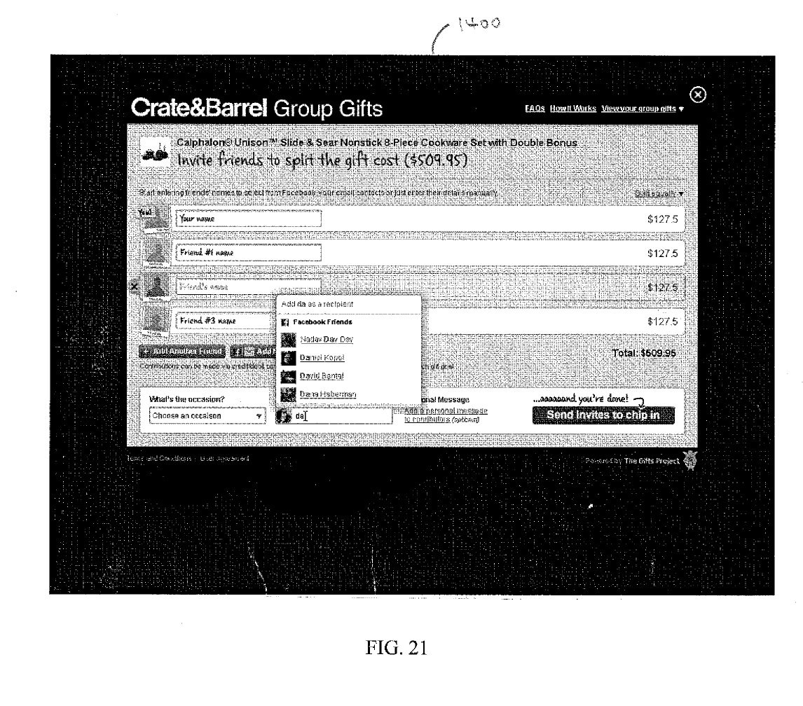

FIG. 21 is a screen showing entering of a gift recipient's name, in accordance with one or more embodiments. The recipient's name can be selected from Facebook or entered manually in a pop up box 2001, as shown in FIG. 21.

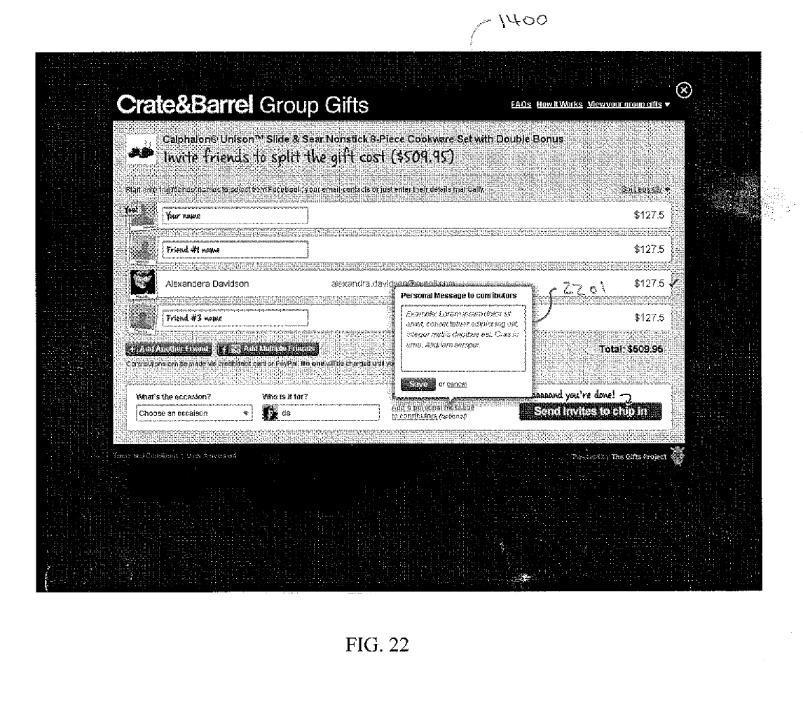

The organizer can have the option of adding a personal message to friends. The message will be included in the Facebook and email invitations that are sent to friends (FIG. 22).

FIG. 22 is a screen showing adding of a personal message, in accordance with one or more embodiments. The organizer or another person can type any desired message into a pop up box 2201.

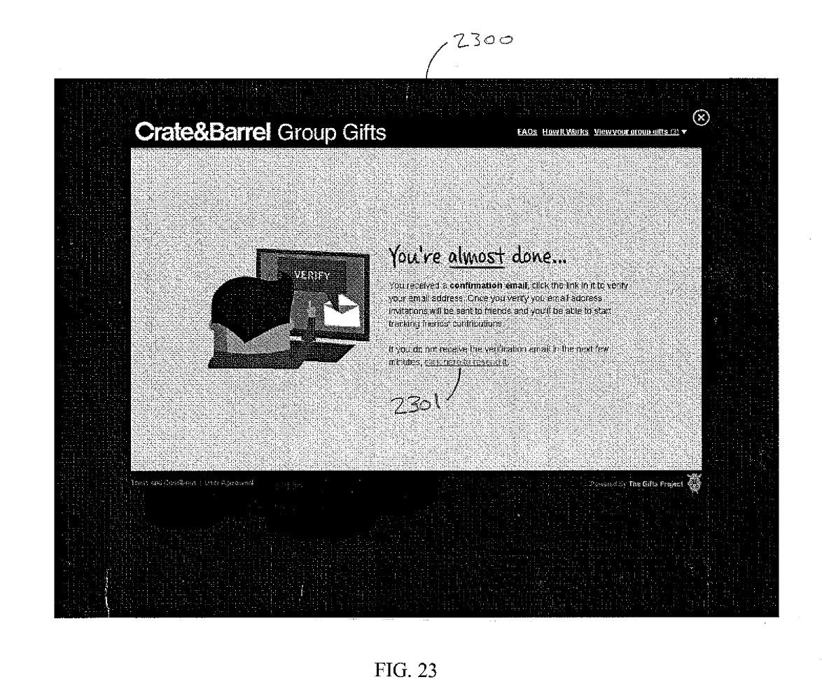

FIG. 23 is a screen showing a confirmation page 2300, in accordance with one or more embodiments. After the organizer completes the invite friends process described above and clicks on the “Send invites to chip in” button, the organizer can be redirected to the confirmation page 2300, where he can be asked to verify his email address. At the same time, the organizer can receive a confirmation email to his inbox with a link to the hosting ecommerce website and short message, asking him to verify his email address.

The user can confirm his email address by clicking on the link 2301 that is included in the confirmation email. Optionally, invitations will not be sent to friends until the organizer confirms the friends email address. The organizer can resend the confirmation email if he does not receive the original email.

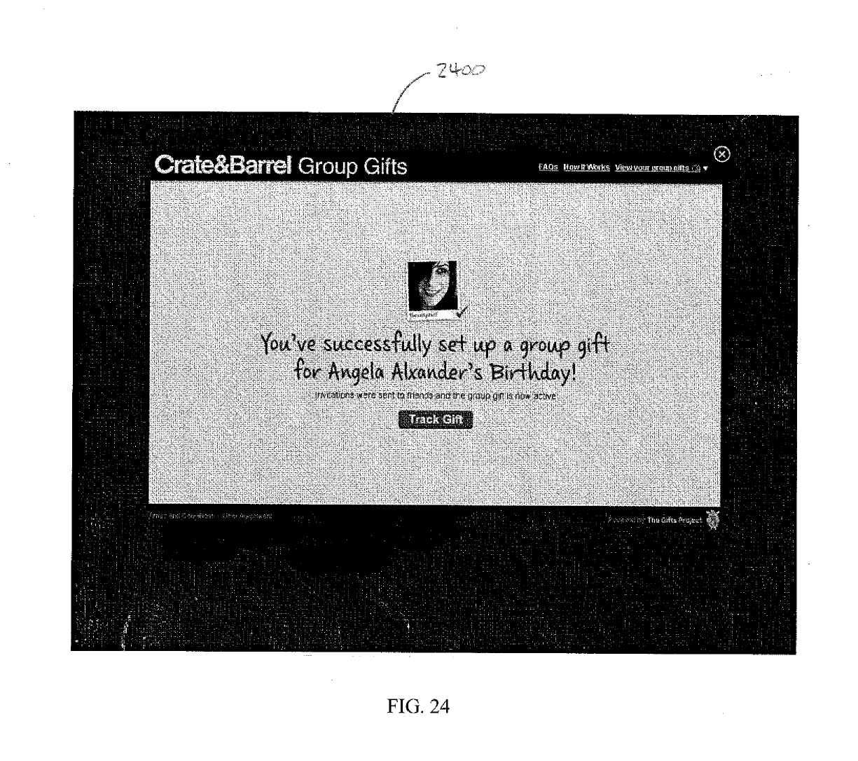

If an organizer is already logged in or used Facebook/Twitter connect, he will not be redirected to the confirmation page 2300. Instead, the organizer can be redirected to the success 2400, as shown in FIG. 24. In this case, invitations can be sent immediately after creating the Group Gift.

FIG. 24 is a screen showing a success page 2400, such as for use when an organizer is already logged in or used Facebook/Twitter connect, in accordance with one or more embodiments.

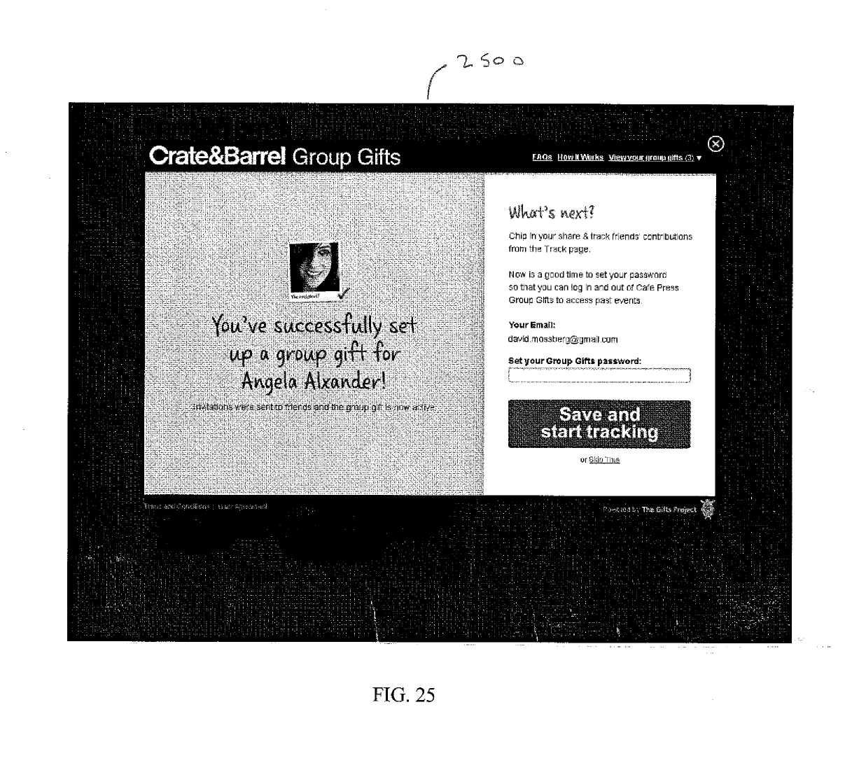

FIG. 25 is a screen showing a success page 2500 such as after clicking on a confirmation link, in accordance with one or more embodiments. After clicking on the link in the confirmation email, the organizer can be redirected to the success page 2400.

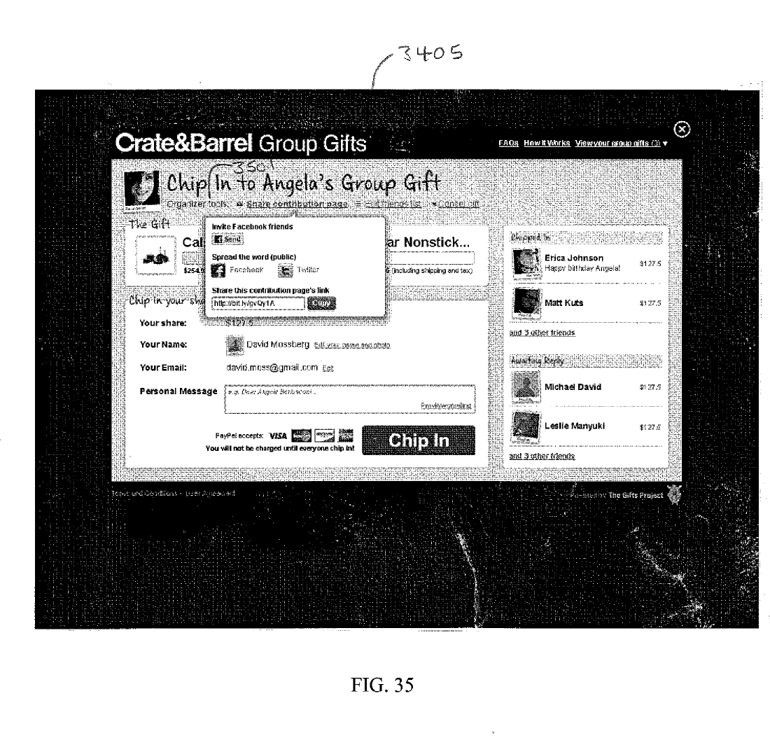

The group purchase system can be configured such that the invitations will be sent to the friends only after the organizer enters the success page 2400. On the success page 2400, the organizer has the option to set a Group Gifts PIN code (or they can choose to skip this step and can use the PIN code that was created for them by the system and sent in a confirmation email) and continue to the track page 3500 of FIG. 35, where the organizer chip in, start tracking friends' contributions and manage the Group Gift.

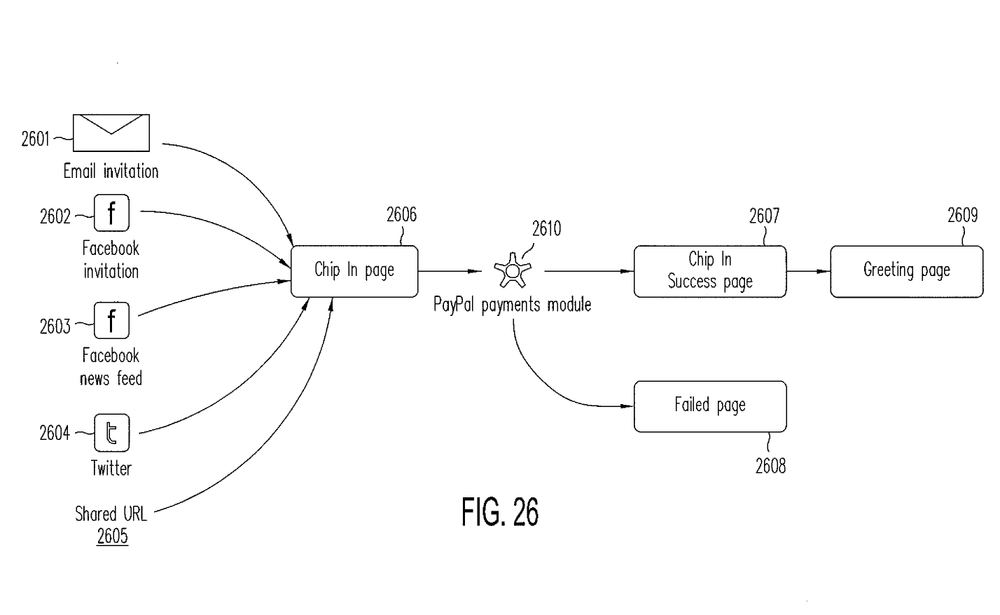

FIG. 26 is a flow chart showing process flow for chipping in, in accordance with one or more embodiments. In the chip in process, the contributing users chip in or provide contributions of money for the group purchase. Contributing users can provide inputs to a chip in page 2606. For example, contributing users can provide inputs to the chip in page 2606 via an email invitation response 2601, a Facebook invitation response 2602, a Facebook newsfeed 2603, Twitter 2604, or a shared uniform resource locater (URL) 2605.

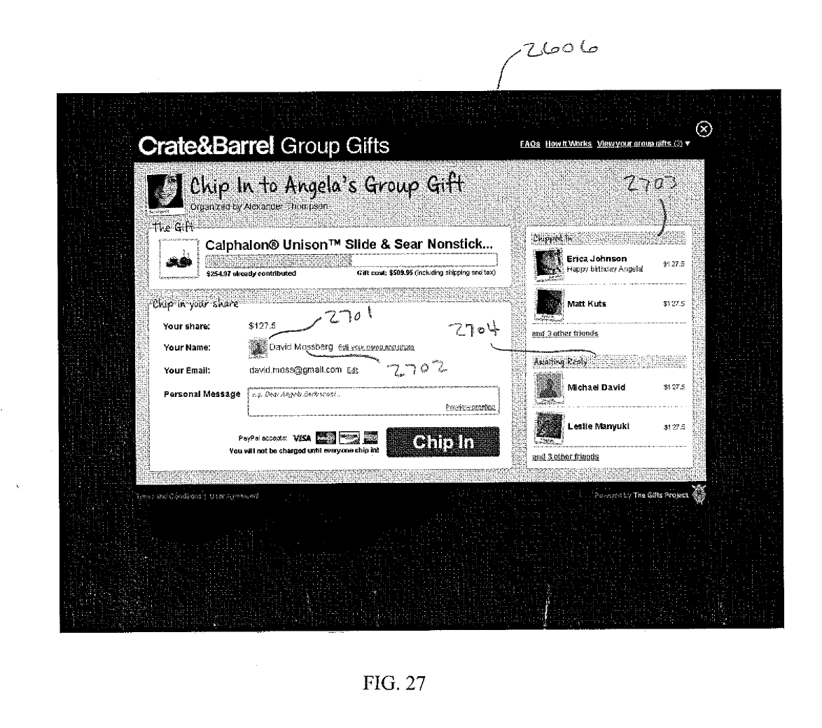

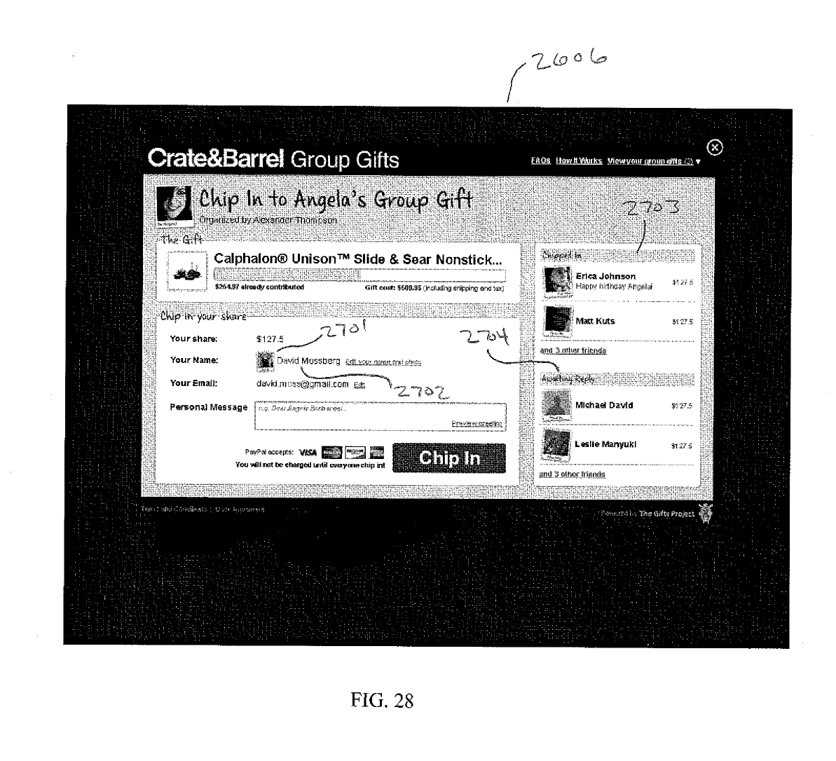

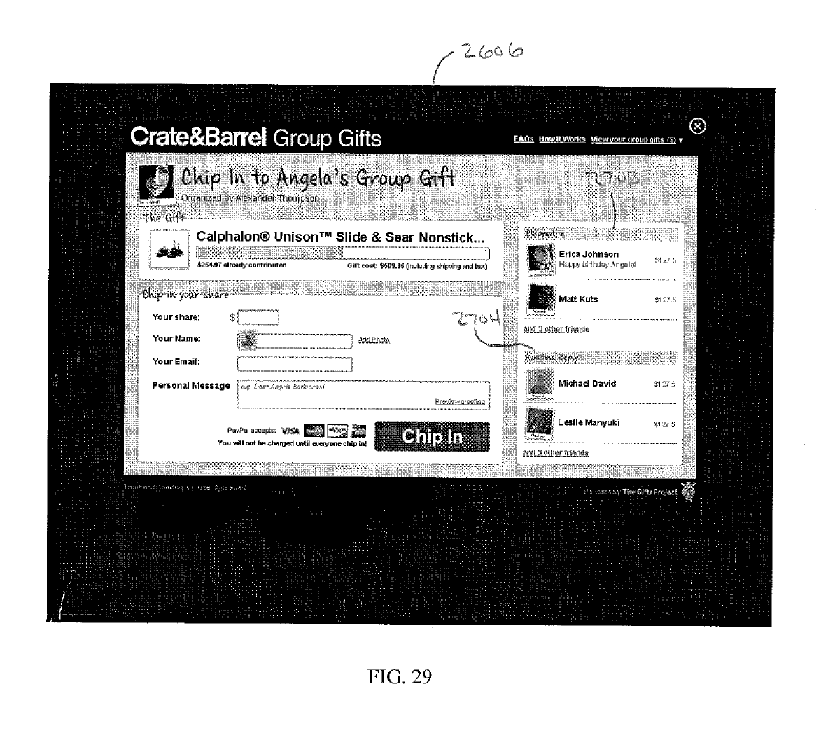

FIGS. 27-29 show the chip in page 2606, in accordance with one or more embodiments. Friends or contributing users can be invited to chip in page via several methods. FIG. 27 is a screen showing the chip in page 2606 that a group member can enter from an email invitation wherein the organizer has suggested an amount to be chipped in, in accordance with one or more embodiments. FIG. 28 is a screen showing the chip in page 2606 that a group member can enter from a Facebook invitation wherein the organizer has suggested an amount to be chipped in, in accordance with one or more embodiments. FIG. 29 is a screen showing a chip in page 2606 that a group member can enter from a share URL wherein the app has no information regarding the group member, in accordance with one or more embodiments.

Private invitation methods include email and Facebook invitations. Public invitation methods include Facebook, Newsfeeds, Twitter, or a shared URL. Once the user clicks on an invitation link (which all of the invitation methods include), the invitee can be redirected to the chip in page (such as on the top of the relevant product page). An overlay of the chip in page 2606 can be opened immediately when the invitees enter the product page.

On the chip in page 2606 the invitee can chip in and share and add a personal message which will be included in the collective e-card (and eventually sent to the gift recipient). The invitee's information can be prefilled according to the invitation method. For example, when an invitee enters the chip in page 2606 from a Facebook invitation, the Group Gifts app can prefill his picture 2701 and name 2702, as shown in FIG. 27. However, if the invitee enters the site from an email invitation for example, the Group Gifts app may only prefill the invitee's email address and name, but not the invitee's profile picture. The suggested amount to chip in on the chip in page can either be a fixed amount (such as can occur when the organizer split the gift goal equally or set amounts manually) or an input field that can be filled by the invitee with an amount (such as can occur when the organizer chose not to suggest amounts to friends).

On the right side of the chip in page 2606 can be two friends' lists. A chipped in friends or contributing users list 2703 shows friends who already chipped in for the gift. An awaiting reply friend or invitees list 2704 show friends who have yet to chip in for the gift.

The contributing users list 2703 and the invitees list 2704 can display friends' names and personal message. If the gift goal is split equally amount friends, the suggested amount for each friend can be displayed to both the organizer and the invitees/contributors. If the organizer has chosen to split the amount manually or does not suggest an amount, the amount one contributes can be anonymous to all but the organizer.

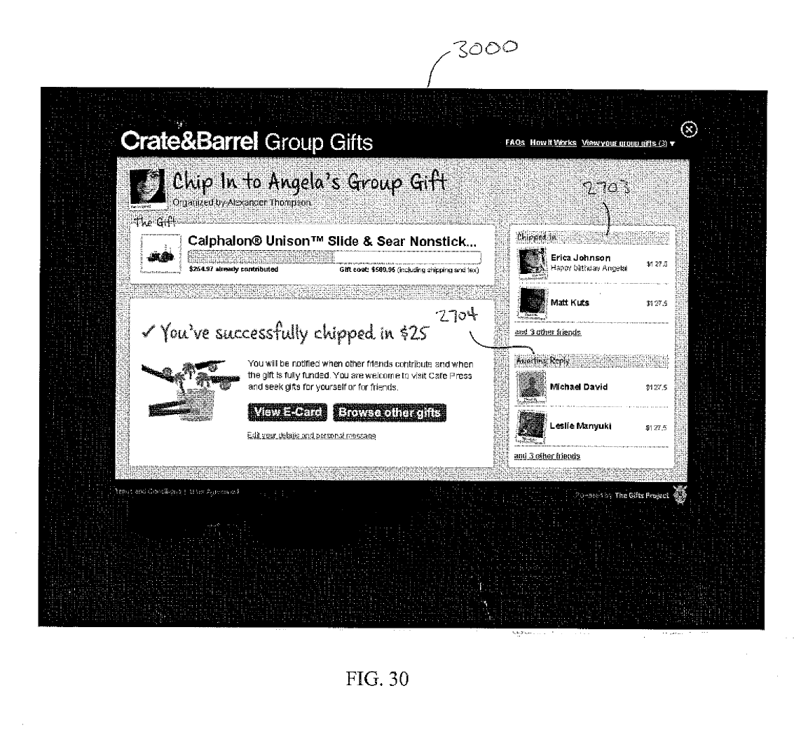

FIG. 30 shows a chip in success page 3000, in accordance with one or more embodiments. After completing the payment transaction successfully (such as via PayPal Adaptive Payments), the user can redirected to the hosting e-commerce site with the chip in success page 3000 opened on top of the product page.

The user can be instructed to view a collective e-card where he can see fellow contributor's personal messages or leave the chip in success page 3000 overlay and check out other items on the hosting e-commerce site. The user can optionally edit the user's personal message and personal details that were entered prior to chipping in.

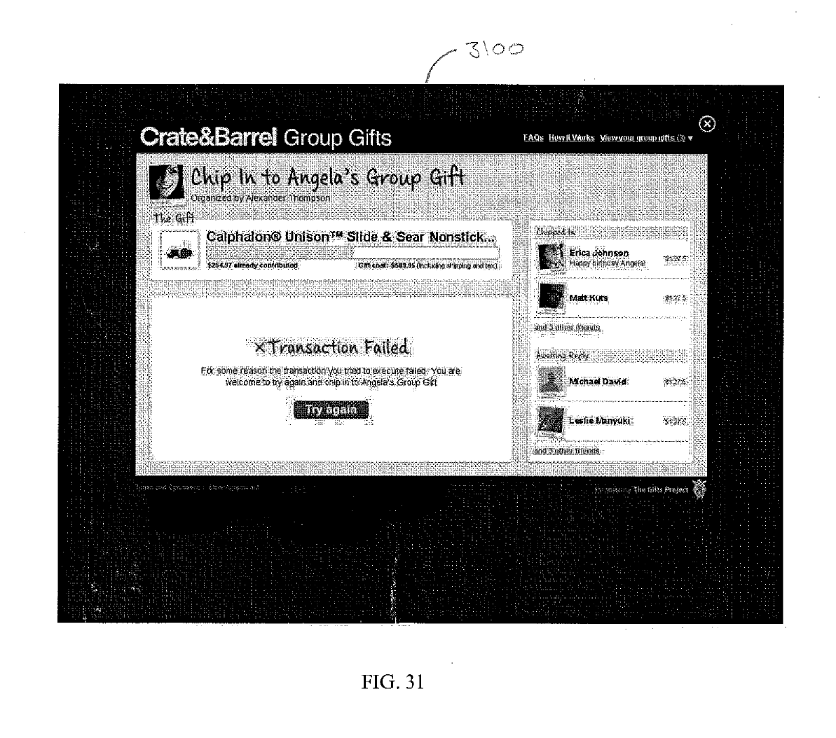

FIG. 31 shows chip in failed page 3100, in accordance with one or more embodiments. If the payment transaction fails, the user can be redirected to the failed page 3100 that can encourage the user to try to chip in again.

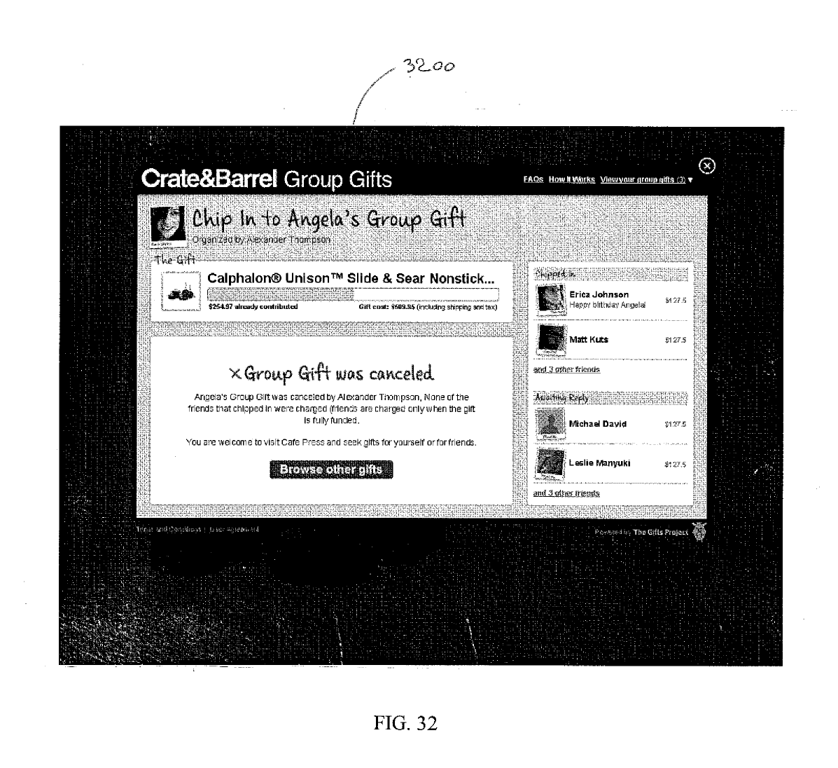

FIG. 32 show a group gifts canceled page 3200, in accordance with one or more embodiments. If the organizer decides to cancel the gift, the contributors will be notified and the chip in page 2606 will indicate that the organizer has canceled the group gift. Friends viewing the chip in page 2606 can be encouraged to check out other items for purchase on the hosting e-commerce website.

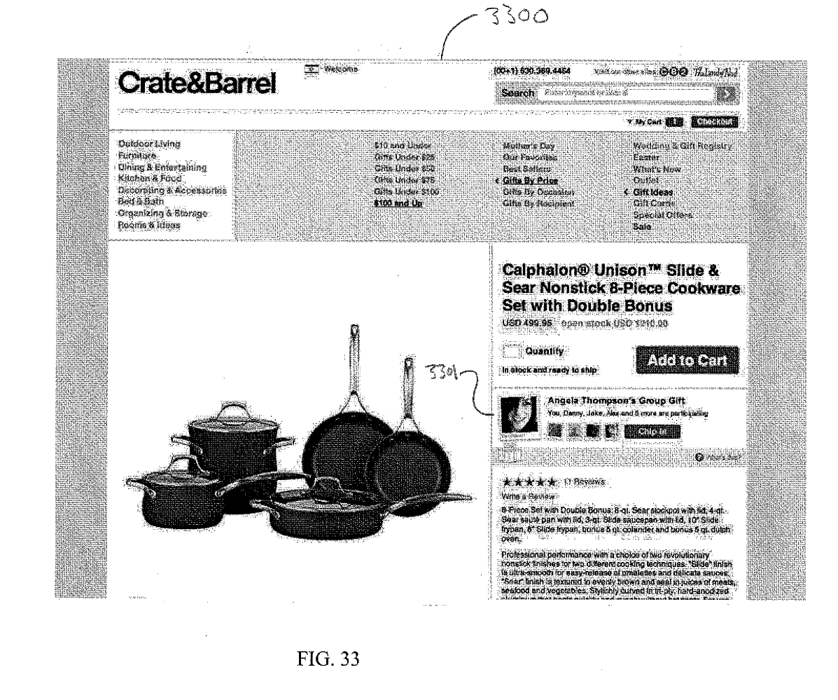

FIG. 33 shows a product page 3300 having chip in widget 3301, in accordance with one or more embodiments. If an invitee closes the chip in page 2606 overlay or enters the product page 3300 by searching/browsing the hosting e-commerce site, the widget 3301 can be displayed in a “chip in state” that will enable the user to reopen the chip in page 2606.

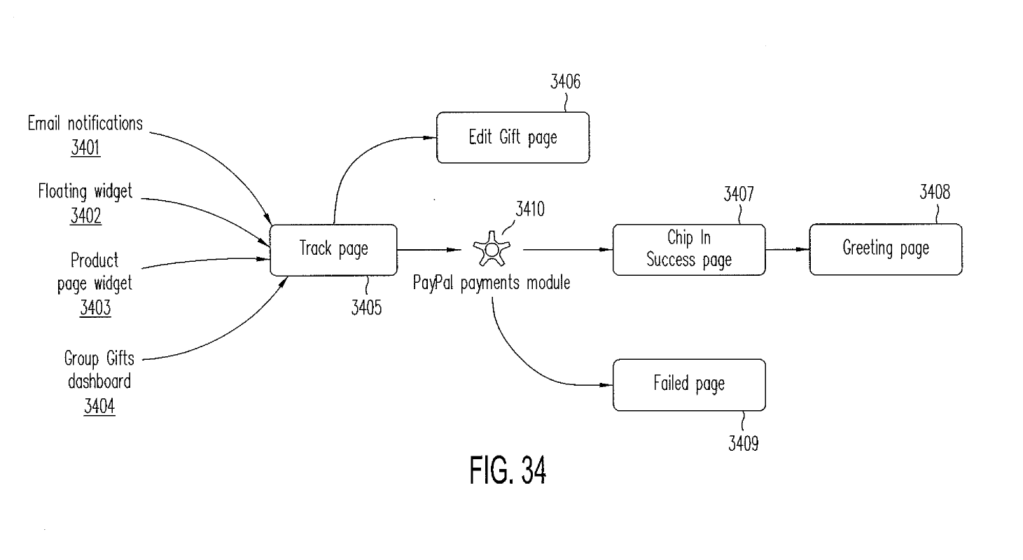

FIG. 34 is a flow chart showing tracking contribution flow, in accordance with one or more embodiments. Tracking is a process by which the organizer, or any other person, can monitor the progress of contribution of money for the group purchase. Tracking can be limited to the organizer, if desired.

Email notifications 3401, a floating widget 3402, a product page widget 3403, or a group gifts dashboard 3404 can lead a user to a track page 3405. From the track page 3405, the user can go to an edit gift page 3406 or to a payment provider, such as a PayPal payment module 3410.

If the chip in is successful, the PayPal payment module 3410 can lead to a chip in success page 3407. If the chip in is unsuccessful, the PayPal payment module 3410 can lead to a chip in failed page 3409. The chip in success page 3407 can lead to a greeting page 3408.

FIG. 35 shows the track page 3405, in accordance with one or more embodiments. The track page 3405 can be very similar to the chip in page 2606. The main difference can be the additional “Organizer tools” 3501 (displayed under the page title), which help the organizer manage the gift and track friends' contributions.

The organizer tools 3501 can include an edit friends list tool, a ping friends tool, a cancel gift tool, and a share contribution page. The edit friends list tool can facilitate the invitation of more friends to contribute and the removal of friends that haven't contributed or change suggested amounts. The ping friends tool can facilitate the sending of reminders by the organizer to friends to chip in. The cancel gift tool can facilitate canceling the gift, such as by the organizer.

The share contribution page tool can facilitate use public invitation methods by the organizer. For example, the share contribution page tool can facilitate use public invitation methods for purposes such as sharing the contribution page URL, publishing a newsfeed of Facebook, or posting a tweet.

The organizer can be required to chip in like any other friend that was invited. Alternatively, the organizer is not required to chip in.

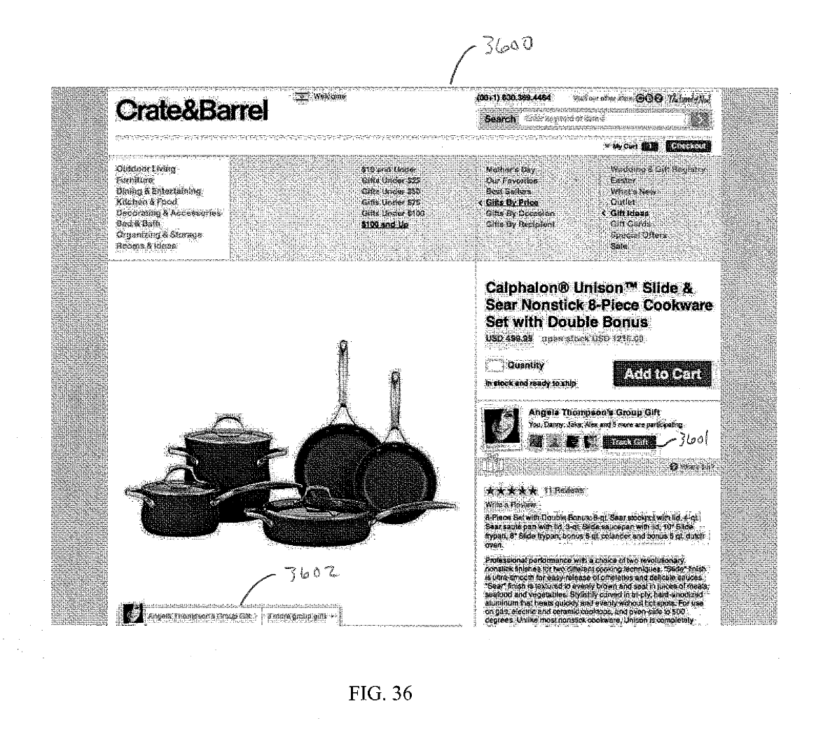

FIG. 36 is a screen showing a product page 3600 with engagement widgets as can be a page seen when the organizer views the website, in accordance with one or more embodiments. After creating a group gift, the product page widget 3601 can change from its “Split the Cost” state to “Track” state and can becomes an additional entry point to the track page 3500. A floating widget 3602 can displayed, such as on the bottom of the hosting e-commerce site's pages, and can facilitate access to existing group gifts.

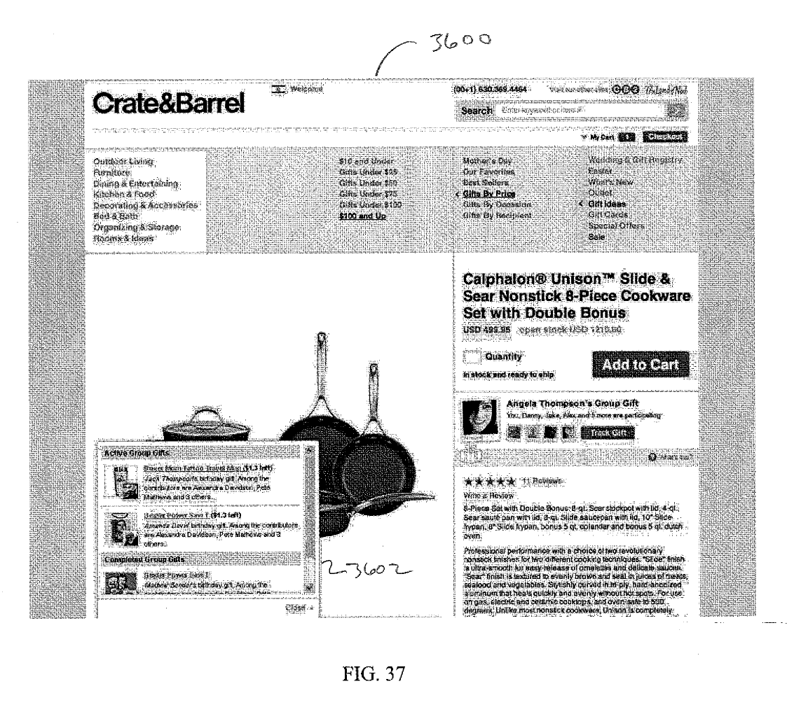

FIG. 37 shows the product page 3600 with the floating widget 3602 expanded in a track state, in accordance with one or more embodiments. The expanded floating widget 3602 can include a listing of active group gifts and a list of completed group gifts.

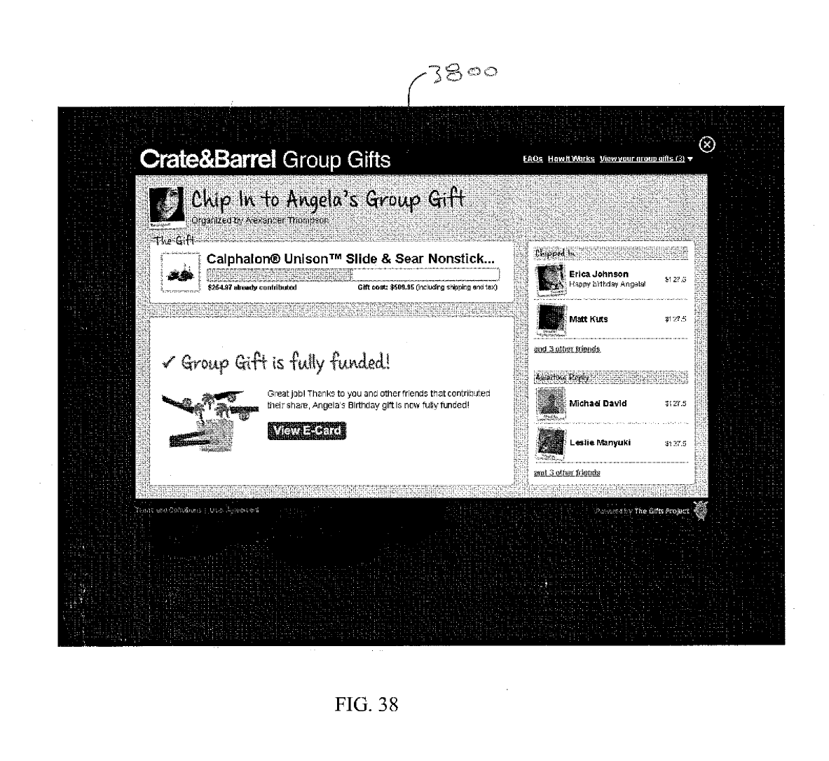

FIG. 38 shows a group gift fully funded chip in page 3800 as a contributor can view the page, in accordance with one or more embodiments. The group gift fully funded chip in page 3800 indicates the group gift has been fully funded.

When the gift is fully funded, friends who chipped in will be charged and notified via that enough money has been raised to purchase the gift. In addition, the Chip In page 2606 will indicate that the gift was fully funded. The user can be encouraged to view the collective e-card or check out other items on the hosting e-commerce site.

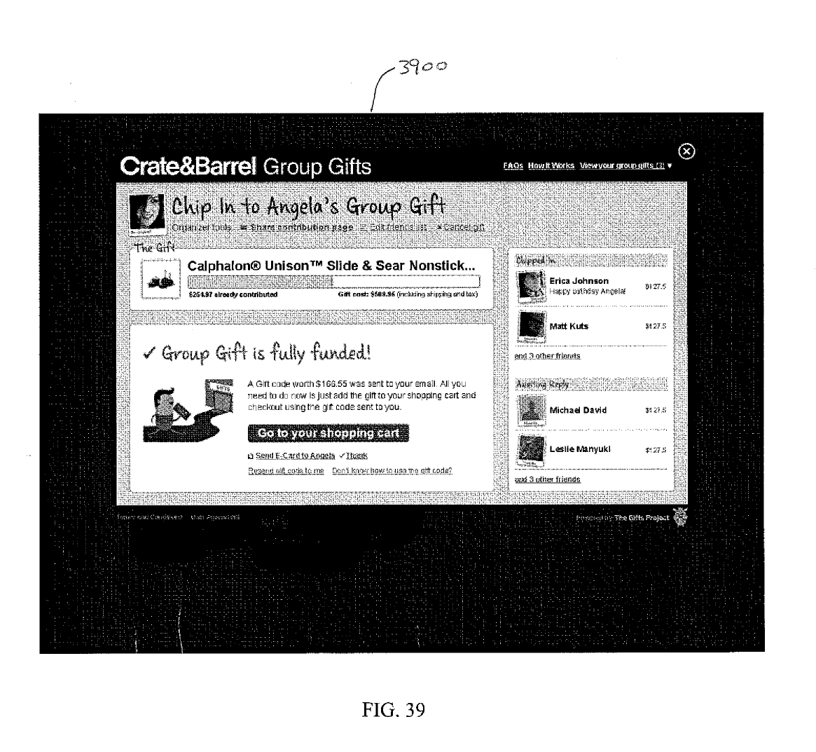

FIG. 39 shows a group gift fully funded organizer view of a chip in page 3900. When the gift has been fully funded, the organizer can be notified, such as via email. The email can include a gift code worth the collected amount.

The track page can indicate that the group gift is fully funded. The track page can direct the organizer to checkout and purchase the gift using the gift code, which can be sent to his email address, as discussed above.

Once the gift is fully funded, the organizer can be permitted to send the collective e-card to the gift recipient, thank the contributors, and resend the gift code. These functions can be performed from the track page, for example.

Thus, the organizer can send the collective e-card to the recipient. The collective e-card can include all of the contributors' personal messages.

The organizer can enter a thank you note that will be sent to the friends that contributed. The thank you note can be sent to all of the friends that contributed. The thank you note can be sent to selected friends that contributed.

The organizer can, if desired, resend the gift code, such as to the organizer email address. The gift code can be sent to any desired email address. The gift code is worth the collected amount.

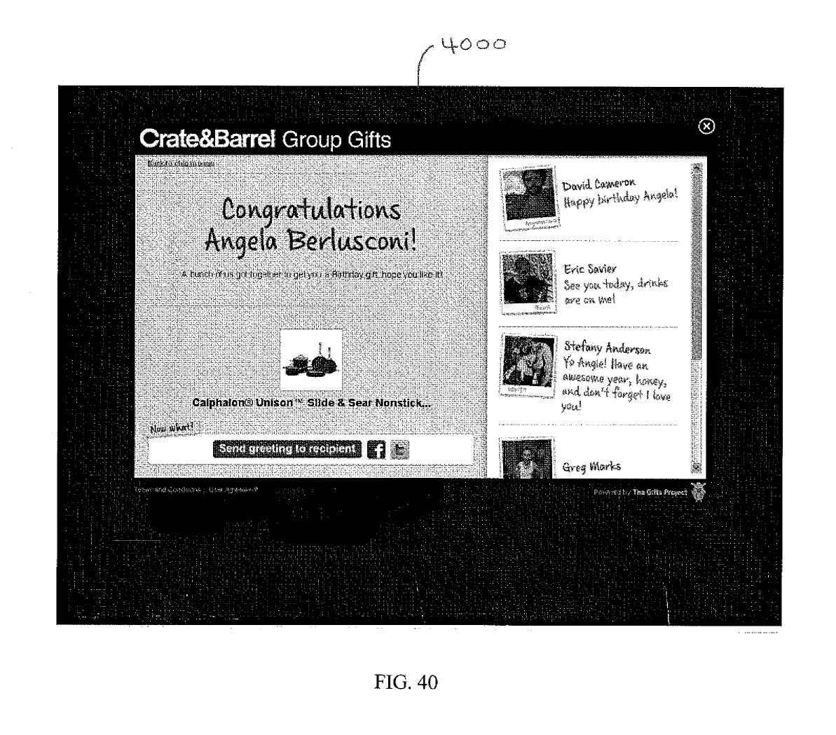

FIG. 40 is a screen showing an email template 4000, in accordance with one or more embodiments. The organizer can send the collective e-card to the recipient as soon as the gift is fully funded. In addition the organizer can publish a newsfeed on Facebook/or Tweet about the gift once it is fully funded.

The recipient will receive a link to the e-card via email. As displayed above, the e-card includes the icon and full title of the gift as taken from the product page and pictures of friends who chipped in and their personal message. The recipient can thank friends via email and or publish a newsfeed on Facebook or tweet about the gift to show their appreciation.

A group gifts dashboard can facilitate functions such as viewing active or completed group gifts. The group gifts dashboard can provide other function, such as tracking contribution progress, as discussed above.

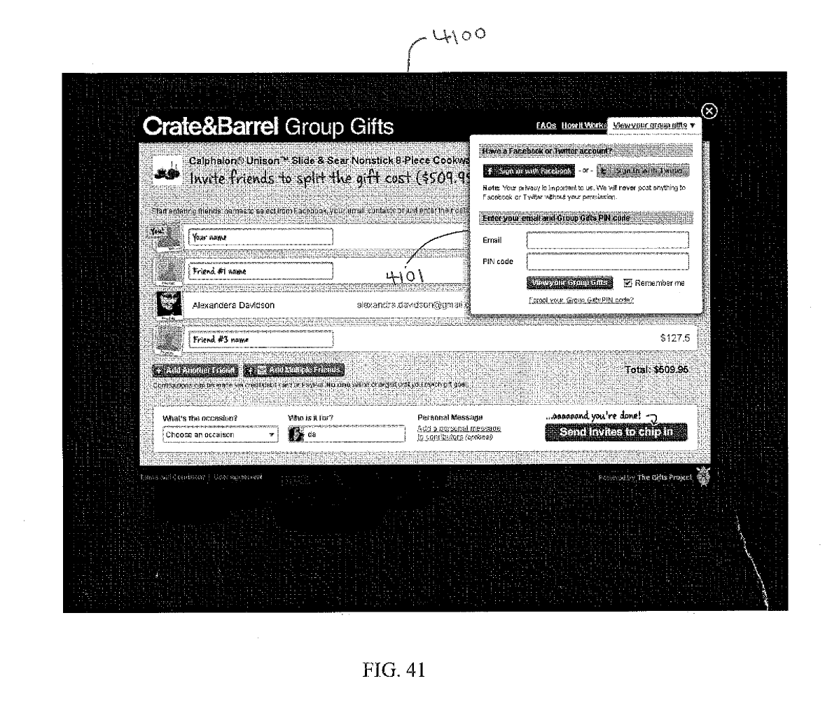

FIG. 41 is a screen showing a user identification page 4100 on a group gifts plugin, such as a Facebook or Twitter group gifts identification, in accordance with one or more embodiments. A box 4101 can open to facilitate entry of a user's email address and PIN code to facilitate identification of the user.

Organizers can view existing Group Gifts, such as by clicking on the “View your Group Gifts” link. The “View your Group Gifts” link can be located in every page header, for example.

In order to view existing Group Gifts the user can be required to be identified by the Group Gifts app. Once the organizer is identified he will be able to view the group gifts dashboard which displays active and completed group gifts created by the organizer.

The group gifts plugin can uniquely identify users using several methods. For example, the group gifts plugin can uniquely identify user via Facebook Connect, Twitter, Group Gifts login. The group gifts plugin can uniquely identify users using any desired method of identification.

After creating a group gift or chipping in, a cookie can be saved on the user's computer in order to easily identify the user. Such use of cookies can be enabled and disable by the organizer. Such use of cookies can be enabled and disable by each user with respect to the user's computer.

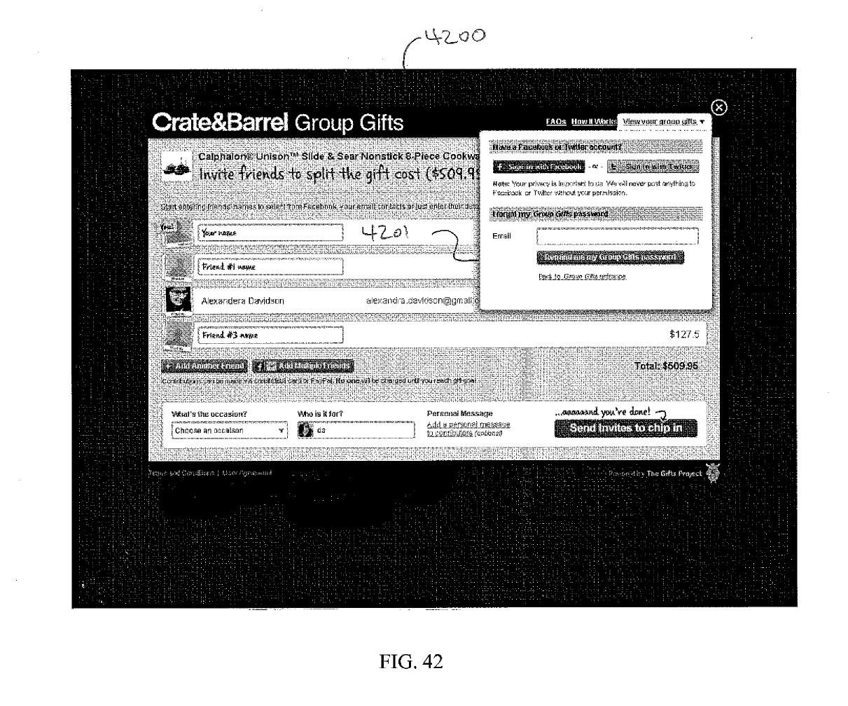

FIG. 42 shows lost PIN page 4200. An email box 4201 can be used when a user forget the user's PIN code. The user can request a new PIN code. The new PIN code can be sent to the user's email address. New PIN code can be sent only to know email address so as to maintain desired security with respect to the group purchase process.

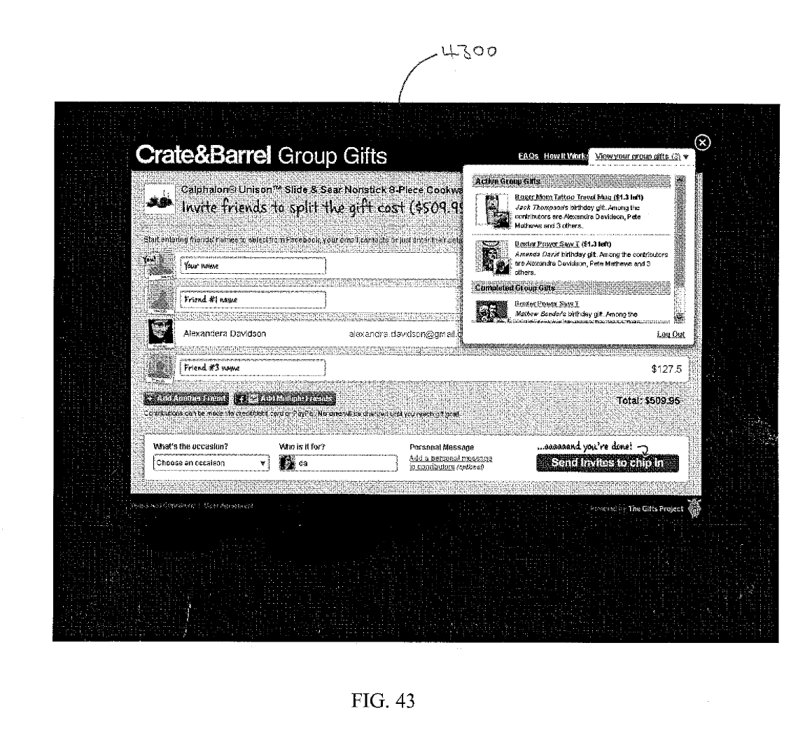

FIG. 43 shows a group gifting dashboard 4300. The group gifting dashboard 4300 displays active group gifts and completed group gifts.

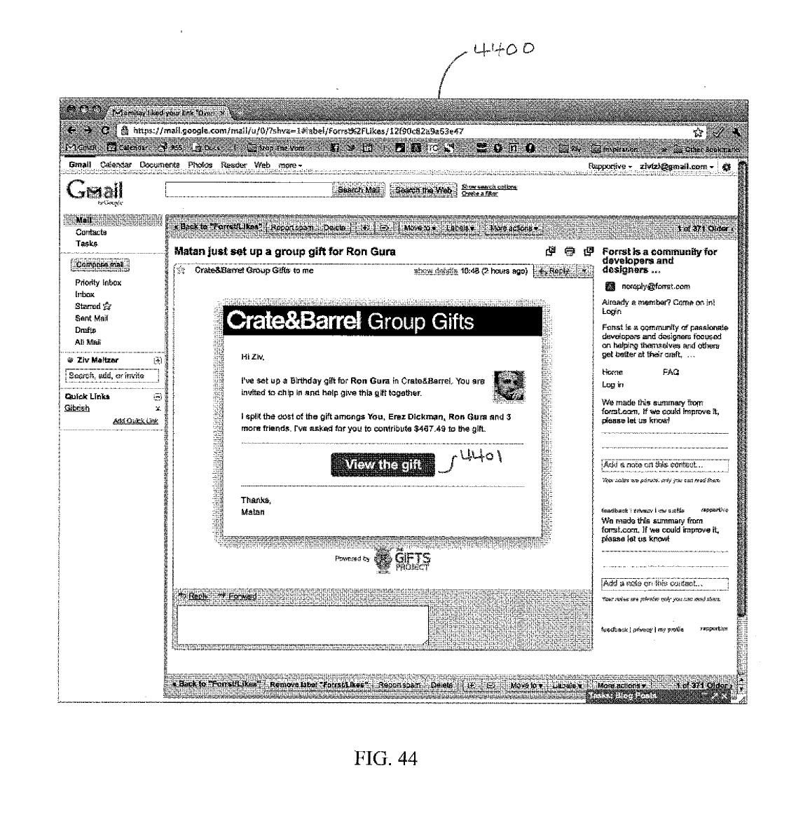

FIG. 44 shows an email template 4400. The email template 4400 facilitates viewing of the gift, such as by clicking on the “View the gift” button. The email template 4400 allows the recipient to participate in the group purchase process for the gift. For example, the recipient can respond to the email by viewing the gift and then contributing to the purchase.

Sharing the cost of a purchase among members of a group make the purchase more affordable. Thus, more purchases and more expensive purchases are likely to be made. The benefits of such group purchase can extend beyond the retailers who directly benefit via increase sales. The benefits can include stimulation of the economy and the consequent growth in jobs and gross national product (GNP).

Encouraging people to come together as a group can also have social and consumer benefits. Social relationships can be fostered and these social relationships can result in lifetime friendships. The consumer benefits can include increased competition as retailers reduce their prices to attract such groups.

The terms “user” and “group member” can be used synonymously herein. The term “organizer” can be used herein to refer to a group member who initiates, coordinates, manages, and/or organizes a group purchase. The organizer can make the purchase or another person, e.g., group member, can make the purchase. The person, e.g., group member, who makes the purchase can be referred to herein as a purchasing user. Those people, e.g., group members, who contribute money to the group purchase can be referred to herein as contributing users.

The term “social network” as used herein can include any computer, telephone, cellular telephone, or other network, that facilitates communication between group members. The term “social network” as used herein can include any computer, server, communications equipment, or the like, that facilitates communication between members. Examples of social networks include Facebook, Twitter, and Myspace. The term “social network” as used herein can refer to any combination of networks such as Facebook, Twitter, and Myspace.

The term “payment provider” as used herein can include payment services such as Paypal, Inc. The payment provider can include an ewallet or the ewallet can be separate from the payment provider.

The term “ewallet” as used herein can include an account that facilitates payment, such as for items purchased online. For example, the ewallet can be a digital wallet and can be associated with a payment provider.

The term “purchase” as used herein can apply to a product, a service, or any combination thereof. The term “purchase” can apply to anything that can be bought or sold. For example, the term “purchase” can apply to a financial instrument such as a stock or bond, an option (whether or not the option is a financial instrument), or anything else.

The purchased item can be for use by the purchasing user, the group, one or more people outside of the group, or anyone else. The purchased item can be a gift that is to be given to purchasing user, the group, one or more people outside of the group, or anyone else.

Discussion herein of the purchased item as being a gift is by way of example only and not by way of limitation. The purchased item can be a gift or can not be a gift.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media.

In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure.

Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a memory storing account information for a plurality of contributing users and a purchasing user;
a processor operable to:
receive a communication indicating an agreement of each of the contributing users to participate in a group purchase transaction by transferring money to the purchasing user;
access accounts of the contributing users and the purchasing user;
transfer money from the accounts of the contributing users into the account of the purchasing user; and
authorize the group purchase transaction with a merchant for the purchasing user.

2. The system of claim 1, wherein the processor is a processor of a payment provider.

3. The system of claim 1, wherein the merchant is an online merchant.

4. The system of claim 1, wherein the contributing users and the purchasing user are members of a social network.

5. The system of claim 4, wherein the processor is operable to cooperate with the social network to define the contributing users and the purchasing user.

6. The system of claim 4, wherein the processor is operable to cooperate with the social network to receive the communication indicating the agreement to participate in a group purchase transaction.

7. The system of claim 1, wherein the processor is operable to receive the communication indicating the agreement to participate in a group purchase transaction via email.

8. The system of claim 1, wherein the communication is facilitated by an API.

9. The system of claim 1, wherein the communication is facilitated by an external API embedded in code of a merchant website.

10. The system of claim 1, wherein the processor is operable to authorize the group purchase transaction only after sufficient money has been transferred to make the purchase.

11. A method comprising:
storing, in a memory, account information for a plurality of contributing users and a purchasing user;
receiving, electronically by a processor, a communication indicating an agreement of each of the contributing users to participate in a group purchase transaction by transferring money to the purchasing user;
accessing, electronically by the processor, accounts of the contributing users and the purchasing user;
transferring, electronically by the processor, money from the accounts of the contributing users into the account of the purchasing user; and
authorizing, electronically by the processor, the group purchase transaction with a merchant for the purchasing user.

12. The method of claim 11, wherein the processor is a processor of a payment provider.

13. The method of claim 11, wherein the merchant is an online merchant.

14. The method of claim 11, wherein the contributing users and the purchasing user are members of a social network.

15. The method of claim 14, wherein the processor is operable to cooperate with the social network to define the contributing users and the purchasing user.

16. The method of claim 14, wherein the processor is operable to cooperate with the social network to receive the communication indicating the agreement to participate in a group purchase transaction.

17. The method of claim 11, wherein the processor is operable to receive the communication indicating the agreement to participate in a group purchase transaction via email.

18. The method of claim 11, wherein the communication is facilitated by an API.

19. The method of claim 11, wherein the communication is facilitated by an external API embedded in code of a merchant website.

20. The method of claim 11, wherein the processor is operable to authorize the group purchase transaction only after sufficient money has been transferred to make the purchase.

21. A computer program product comprising a non-transitory computer readable medium having computer readable and executable code for instructing a processor to perform a method, the method comprising:
storing, in a memory, account information for a plurality of contributing users and a purchasing user;
receiving, electronically by a processor, a communication indicating an agreement of each of the contributing users to participate in a group purchase transaction by transferring money to the purchasing user;
accessing, electronically by the processor, accounts of the contributing users and the purchasing user;
transferring, electronically by the processor, money from the accounts of the contributing users into the account of the purchasing user; and
authorizing, electronically by the processor, the group purchase transaction with a merchant for the purchasing user.
